(19) United States
(12) Patent Application Publication
(10) Pub. No.: US 2026/0220192 A1
(43) Pub. Date: Jul. 30, 2026

(54) DOCUMENT SEARCH DEVICE AND DOCUMENT SEARCH METHOD

(71) Applicant: SEMICONDUCTOR ENERGY LABORATORY CO., LTD., Atsugi-shi, Kanagawa-ken (JP)

(72) Inventors: Yoshitaka DOZEN, Atsugi-shi, Kanagawa-ken (JP); Junpei MOMO, Sagamihara, Kanagawa (JP); Kunitaka YAMAMOTO, Atsugi, Kanagawa (JP)

(21) Appl. No.: 19/140,127

(22) PCT Filed: Dec. 15, 2023
(86) PCT No.: PCT/IB2023/062743

§ 371 Date: Jun. 17, 2025

(30) Foreign Application Priority Data
Dec. 22, 2022 (JP) 2022-205521

(51) Int. Cl. G06F 16/583; G06F 16/532; G06F 16/538; G06F 16/55

(52) U.S. Cl. CPC G06F 16/583; G06F 16/532; G06F 16/538; G06F 16/55

(57) ABSTRACT

A document search device that can search for a text whose concept is similar to a desired concept is provided. The document search device includes an image generation portion and an image search portion. The image generation portion generates search target images on the basis of search target texts included in a search target document. A query image is generated on the basis of a query text. The image search portion calculates the degrees of similarity between the search target images and the query image, and specifies the search target text used in the generation of the search target image with a high degree of similarity as a search target text to be presented to a user of the document search device.

### TECHNICAL FIELD

One embodiment of the present invention relates to a document search device and a document search method. Another embodiment of the present invention relates to a document search system.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor), an input/output device (e.g., a touch panel), a method for driving any of them, and a method for manufacturing any of them.

### BACKGROUND ART

Intellectual property rights such as patents, designs, and trademarks have gained interest and awareness, and technologies to support the effective use of patents are being developed. In order to verify whether one's patented invention is implemented by other companies, other companies' products need to be compared with one's patent to determine whether they infringe the patent. Frequent verification is required to ensure that one's products are protected by its patents when existing products are improved as well as when new products are launched, for example.

Patent Document 1 discloses a system that can search for information relevant to input intellectual property information. For example, it is possible to search for patent documents, papers, or industrial products that are similar to a designated patent document.

### REFERENCES

### Patent Document

[Patent Document 1] PCT International Publication No. 2019/180546

### Non-Patent Documents

[Non-Patent Document 1] Learning Transferable Visual Models From Natural Language Supervision, Alec Radford et al. (Submitted on 26 Feb. 2021, [online], Internet <URL: https://arxiv.org/abs/2103.00020>
[Non-Patent Document 2] Generative Adversarial Networks, Ian J. Goodfellow et al. (Submitted on 10 Jun. 2014, [online], Internet <URL: https://arxiv.org/abs/1406.2661>

### SUMMARY OF THE INVENTION

### Problems to be Solved by the Invention

In the case of searching for a document including wording similar to wording in a text included in a document, it is difficult to search for a document including a text whose concept is similar to but represented differently from that of the document. In the case of searching for a document including an image whose feature value is similar to that of an image included in a document, it is difficult to search for a document including an image whose concept is similar to that of the document but whose feature value is different from that of the document.

An object of one embodiment of the present invention is to provide a document search device and a document search system each of which can search for a text whose concept is similar to a desired concept. Another object of one embodiment of the present invention is to provide a highly convenient document search device and a highly convenient document search system. Another object of one embodiment of the present invention is to provide a novel document search device and a novel document search system.

Another object of one embodiment of the present invention is to provide a document search method that can search for a text whose concept is similar to a desired concept. Another object of one embodiment of the present invention is to provide a highly convenient document search method. Another object of one embodiment of the present invention is to provide a novel document search method.

Note that the description of these objects does not preclude the existence of other objects. One embodiment of the present invention does not necessarily achieve all of these objects. Other objects can be derived from the description of the specification, the drawings, and the claims.

### Means for Solving the Problems

One embodiment of the present invention is a document search device including an input portion and an output portion, in which the input portion has a function of receiving a query text, the output portion has a function of presenting an output text specified from a plurality of search target texts in each of search target documents in a search target document group, and the output portion has a function of presenting one query image or at least one of a plurality of query images generated on the basis of the query text and an output image specified from one or more images generated on the basis of the output text.

In the above embodiment, the output portion may have a function of presenting information specifying the search target document including the output text.

In the above embodiment, the query image may be an image generated using a machine learning model.

In the above embodiment, the machine learning model may be a neural network model.

In the above embodiment, the output image may be specified on the basis of degrees of similarity between search target images generated from the plurality of search target texts and the query image.

Another embodiment of the present invention is a document search method including a first step of receiving a query text, a second step of generating a plurality of query images on the basis of the query text, a third step of calculating degrees of similarity between a plurality of search target images generated on the basis of a plurality of search target texts in each of search target documents in a search target document group and each of the plurality of query images, a fourth step of specifying at least one of the plurality of search target images on the basis of the degrees of similarity, and a fifth step of specifying the search target text used in generation of the specified search target image.

In the above embodiment, in the second step, a distributed representation may be generated on the basis of the query text and the plurality of query images may be generated on the basis of the distributed representation.

In the above embodiment, in the third step, the degrees of similarity may be obtained by calculating a degree of similarity between a first distributed representation generated from each of the plurality of query images and a second distributed representation generated from each of the plurality of search target images.

In the above embodiment, the first distributed representation and the second distributed representation may be generated using an image classification model or an image caption generation model.

In the above embodiment, in the third step, the query images may be classified as a first classification, the plurality of search target images may be classified as a second classification, and then degrees of similarity between the search target image selected from the plurality of search target images on the basis of the first classification and the second classification and the query images may be calculated.

In the above embodiment, in the third step, the query text may be classified as a first classification, the search target texts may be classified as a second classification, and then degrees of similarity between the search target image selected from the plurality of search target images on the basis of the first classification and the second classification and the query images may be calculated.

Another embodiment of the present invention is a document search method including a first step of receiving a query text, a second step of generating a plurality of query images on the basis of the query text, a third step of calculating first degrees of similarity between a plurality of search target images generated on the basis of a plurality of search target texts in each of search target documents in a search target document group and each of the plurality of query images, a fourth step of calculating second degrees of similarity between the plurality of search target texts and the query text, and a fifth step of specifying at least one of the plurality of search target images and at least one of the plurality of search target texts on the basis of the first degrees of similarity and the second degrees of similarity.

### Effect of the Invention

According to one embodiment of the present invention, a document search device and a document search system each of which can search for a text whose concept is similar to a desired concept can be provided. According to another embodiment of the present invention, a highly convenient document search device and a highly convenient document search system can be provided. According to another embodiment of the present invention, a novel document search device and a novel document search system can be provided.

According to another embodiment of the present invention, a document search method that can search for a text whose concept is similar to a desired concept can be provided. According to another embodiment of the present invention, a highly convenient document search method can be provided. According to another embodiment of the present invention, a novel document search method can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1A is a block diagram illustrating a structure example of a document search device. FIG. 1B is a conceptual diagram illustrating the structure example of the document search device.

FIG. 2A and FIG. 2B are schematic views illustrating an example of processing by an image generation portion.

FIG. 3 is a schematic view illustrating an example of a learning document.

FIG. 4A is a schematic view illustrating an example of a method for obtaining a learning text. FIG. 4B is a schematic view illustrating an example of a learning method of a machine learning model.

FIG. 5 is a schematic view illustrating an example of a search target text.

FIG. 6 is a flowchart showing an example of a document search method.

FIG. 7A to FIG. 7C are schematic views illustrating an example of a document search method. FIG. 7D is a schematic view illustrating a structure example of an image classification model. FIG. 7E is a schematic view illustrating a structure example of an image caption generation model.

FIG. 8A and FIG. 8B are schematic views each illustrating an example of a display mode of search results.

FIG. 9 is a flowchart showing an example of a document search method.

FIG. 10 is a schematic view illustrating an example of a display mode of search results.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments.

In this specification and the like, ordinal numbers such as “first” and “second” are used for convenience and do not limit the number of components or the order of components (e.g., the order of steps or the stacking order of layers). An ordinal number used for a component in a certain part in this specification is not the same as an ordinal number used for the component in another part in this specification or the scope of claims in some cases.

### Embodiment 1

In this embodiment, a document search device and a document search method of one embodiment of the present invention will be described with reference to the drawings.

One embodiment of the present invention relates to a document search device including an input portion, an image generation portion, an image search portion, and an output portion, and a document search method using the document search device. The input portion has a function of receiving a text to be supplied to the image generation portion. The image generation portion has a function of generating an image on the basis of the text. For example, the image generation portion stores a machine learning model, and can generate an image using the machine learning model. The image can be an image representing a concept represented by the text.

The image search portion has a function of comparing generated images and specifying a text to be presented to a user of the document search device as a search result. For example, the image search portion has a function of calculating the degree of similarity between generated images and specifying a text to be presented to the user of the document search device as a search result on the basis of the degree of similarity. The output portion has a function of presenting the text specified by the image search portion to the user of the document search device. For example, the output portion has a function of displaying the text specified by the image search portion.

In the document search method using the document search device of one embodiment of the present invention, the image generation portion generates an image in advance on the basis of a search target text included in a search target document. The image is referred to as a search target image. The search target document can be a document stored in a database, for example. In the case where the search target document is a patent document, for example, the search target text can be a text included in a specification. One search target document can include a plurality of search target texts. For example, one or more paragraphs can be used as one search target text. For another example, one or more sentences can be used as one search target text. For another example, part of one sentence can be used as one search target text.

When the user of the document search device inputs, to the input portion, a query text that is a text including a content the user desires to search for, the image generation portion generates an image on the basis of the query text. The image is referred to as a query image. The user of the document search device can designate one or more paragraphs included in a document as the query text, for example. For another example, one or more sentences can be designated as the query text. For another example, part of one sentence can be designated as the query text.

After the image generation portion generates the query image, the image search portion calculates the degree of similarity between the search target image and the query image. Then, on the basis of the degree of similarity, the image search portion specifies the search target text to be presented to the user of the document search device as a search result. Specifically, the search target text used in the generation of the search target image with a high degree of similarity is specified as the search target text to be presented to the user of the document search device. The output portion presents the specified search target text to the user of the document search device.

As described above, the image generation portion can generate an image representing a concept represented by a text. Thus, the query image can be an image representing a concept represented by the query text, and the search target image can be an image representing a concept represented by the search target text. In this manner, the document search device of one embodiment of the present invention can search for a document including a text whose concept is similar to but represented differently from a desired concept and present the document to the user of the document search device.

Note that the image generation portion can generate a plurality of different images from the same text. For example, when noise is supplied to the image generation portion, a plurality of different images can be generated from the same text. In the case where the image generation portion has a function of generating a plurality of different images from the same text, the image generation portion can generate a plurality of query images from a query text. In addition, the image generation portion can generate a plurality of search target images from one search target text. In that case, the image search portion can calculate the degrees of similarity between the plurality of query images and the plurality of search target images, and the highest degree of similarity can be used as the degree of similarity between the search target image and the query image in the subsequent processing, for example. In the case where the image generation portion has a function of generating three images from one text, for example, the highest degree of similarity among nine degrees of similarity can be used as the degree of similarity between the search target image and the query image in the subsequent processing.

In the case where only one image is generated from one text, the image does not accurately represent the concept of the text in some cases. In view of this, the image generation portion generates a plurality of different images from one text, so that the probability of generating the image accurately representing the concept of the text can be increased. Thus, it is possible to search for a document including a search target text whose concept is similar to that of a query text with higher accuracy and to present the document to the user of the document search device.

### <Structure Example of Document Search Device>

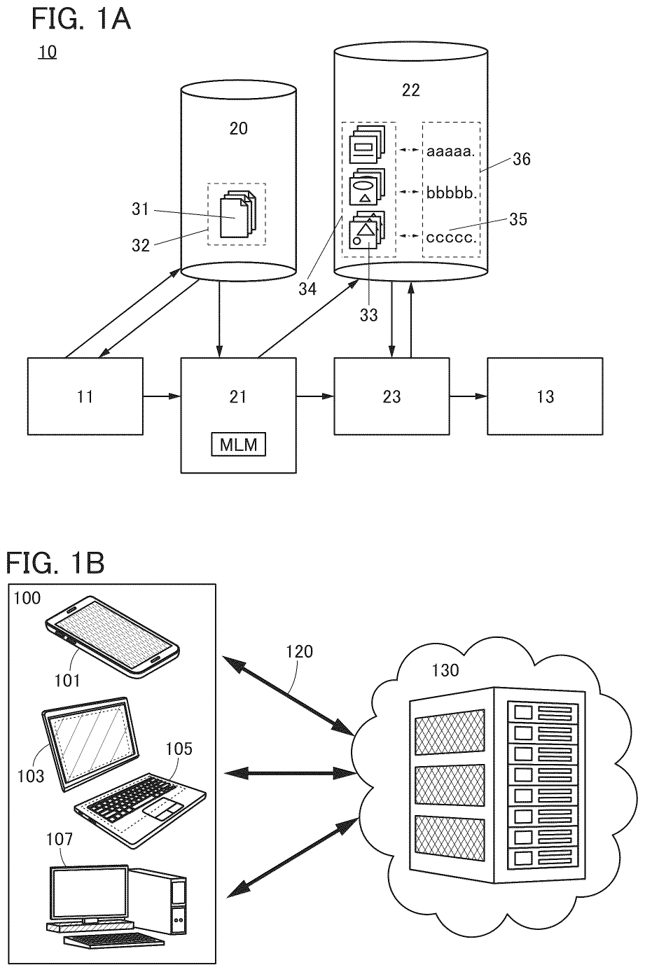

FIG. 1A is a block diagram illustrating a structure example of a document search device 10 that is the document search device of one embodiment of the present invention. The document search device 10 includes an input portion 11, a document storage portion 20, an image generation portion 21, an image storage portion 22, an image search portion 23, and an output portion 13.

In FIG. 1A, exchange of data or the like between the components of the document search device 10 is denoted by arrows. Note that the exchange of data or the like illustrated in FIG. 1A is an example, and data or the like can sometimes be exchanged between components that are not connected by an arrow, for example. Furthermore, data or the like is not exchanged between components that are connected by an arrow in some cases.

Although FIG. 1A is the block diagram showing that components are classified by their functions and illustrated as independent blocks, for example, it is difficult to completely separate actual components according to their functions and one component can relate to a plurality of functions.

### [Document Storage Portion]

The document storage portion 20 stores a search target document 31. The document storage portion 20 can store a plurality of the search target documents 31. In that case, the plurality of search target documents 31 are collectively referred to as a search target document group 32. It can be said that a document database is constructed in the document storage portion 20.

Examples of the search target document 31 include a document relating to intellectual property rights. Examples of the document relating to intellectual property rights include a patent application document, a utility model registration application document, an international application document, a design registration application document, a trademark registration application document, a published patent application, a patent publication, a utility model publication, an international publication, a design publication, an international designs bulletin, a published trademark application, a published international trademark application, and a trademark publication. Here, the patent application document can include a specification, a drawing, a scope of patent claims, an abstract, and an application. The utility model registration application document can include a specification, a drawing, a scope of claims for utility model registration, an abstract, and an application. The international application document can include a specification, a drawing, a scope of claims, an abstract, and an application. The design registration application document can include an application and a drawing. The trademark registration application document can include an application. There is no limitation on statuses of the above applications, i.e., whether or not it is published, whether or not it is pending in the Patent Office, and whether or not it is registered. Any of a document before application, an application before examination, an application under examination, and a registered application can be the search target document 31.

Note that the search target document 31 is not limited to the document relating to intellectual property rights and may be a technical document such as an academic paper or a legal document, for example. Examples of the legal document include contracts, terms and conditions, and precedents. The search target document 31 may be a book, a magazine, a newspaper, a contract, an academic paper, a decision document, terms and conditions, a product manual, a novel, a publication, a white paper, a technical document, a business document, or the like.

### [Input Portion]

The input portion 11 has a function of receiving a text. For example, the input portion 11 can receive a text included in a document. In this specification and the like, a text received by the input portion 11 is referred to as a query text. A document including a query text is referred to as a query document. A query text can be a text including a content that the user of the document search device 10 desires to search for.

For example, a document designated from the search target documents 31 can be used as a query document, and at least part of a text included in the query document can be used as a query text. For example, one or more paragraphs included in the query document can be used as the query text. For another example, one or more sentences included in the query document can be used as the query text. For another example, part of one sentence included in the query document can be used as the query text. In the case where the query document is a patent application document, a utility model registration application document, or an international application document, for example, the query text can be a text included in a specification. The query text can be designated from texts included in the query document by the user of the document search device 10.

In the case where the search target document 31 stored in the document storage portion 20 is used as a query document, the user can specify the query document by designating information specifying the search target document 31. Examples of information specifying a document include identification numbers (IDentification: ID) given to respective documents. For example, a document can be specified by one or more of a title given to the document, the date such as an issue date of the document, a creator of the document, a publisher, a text included in the document, and the like. In the case where the query document is a published patent application, for example, the document can be specified by designating one or more of an application management number for identifying an application (including an internal unique number), an application family management number for identifying an application family, an application number, a publication number, a registration number, an inventor, an applicant, a drawing, an abstract, an application date, a priority date, a publication date, a status, a patent classification, a category, a keyword, and the like.

In this specification and the like, ID may include not only numbers but also characters. In this specification and the like, characters include symbols.

When a plurality of pieces of information are prepared for specifying a document, the document search device 10 can be a highly convenient document search device. A query document is preferably allowed to be designated when a user designates part of the above information. For example, it is preferable to allow a query document to be specified only by designating not the whole but part of a title given to the document, in which case the convenience of the document search device 10 can be increased. When a query document can be specified on the basis of information registered in a device other than the document search device 10, the convenience of the document search device 10 can be further increased.

The input portion 11 has a function of authenticating a user of the document search device 10. For example, when a user of the document search device 10 inputs ID (also referred to as user ID) and a password to the input portion 11, the document search device 10 enables user authentication. Note that the document search device 10 may have a function of conducting authentication on the basis of a figure input to the input portion 11 by a user or a function of conducting biometric authentication using fingerprints, voice prints, or the like. In addition, an authentication portion may be provided in the document search device 10 so that the authentication portion conducts user authentication.

Note that a query document is not necessarily the search target document 31. For example, a document input to the input portion 11 by the user of the document search device 10 may be used as a query document. The document may be stored in the document storage portion 20 and newly registered as the search target document 31. Then, the user of the document search device 10 can designate at least part of a text included in the query document as a query text. A document is not necessarily input to the input portion 11. In that case, for example, the user of the document search device 10 can input a given text to the input portion 11 and the text can be used as a query text.

### [Image Generation Portion]

The image generation portion 21 has a function of generating an image on the basis of a text. For example, the image generation portion 21 stores a machine learning model MLM as an image generation model, and can generate an image using the machine learning model MLM. The image can be an image representing a concept represented by a text. A neural network model can be used as the machine learning model MLM, for example. Examples of the neural network model include CLIP (Contrastive Language-Image Pre-training) and generative adversarial network (GAN). Note that CLIP is disclosed in Non-Patent Document 1, and GAN is disclosed in Non-Patent Document 2. The contents of these papers are incorporated by reference.

The image generation portion 21 has a function of generating an image on the basis of a query text. The image generation portion 21 also has a function of generating an image on the basis of a text included in the search target document 31. In this specification and the like, an image generated on the basis of a query text is referred to as a query image. A text which is included in a search target document and on the basis of which an image is generated is referred to as a search target text. An image generated on the basis of a search target text is referred to as a search target image. A query image can be an image representing a concept represented by a query text. A search target image can be an image representing a concept represented by a search target text.

The image generation portion 21 can generate a plurality of different images from the same text. In that case, the image generation portion 21 can generate a plurality of different query images from a query text. In addition, the image generation portion 21 can generate a plurality of different search target images from one search target text.

One search target document 31 can include a plurality of search target texts. For example, one or more paragraphs can be used as one search target text. For another example, one or more sentences can be used as one search target text. For another example, part of one sentence can be used as one search target text. In the case where the search target document 31 is a patent application document, a utility model registration application document, or an international application document, for example, each paragraph or each sentence included in a specification can be used as a search target text. For example, in the case where the search target document 31 includes a specification with 100 paragraphs, the search target document 31 can include 100 search target texts. Note that some paragraphs are not necessarily included in the search target texts. For example, a paragraph including a predetermined term not suitable for image generation is not necessarily included in the search target texts. In addition, a paragraph composed of only sentences including a predetermined term not suitable for image generation is not necessarily included in the search target texts. Furthermore, one search target text may include a plurality of paragraphs as described above. Here, in the case where a document designated from the search target documents 31 is used as a query document, at least one search target text designated from a plurality of search target texts included in the query document can be used as a query text.

### [Image Storage Portion]

The image storage portion 22 has a function of storing a search target image generated by the image generation portion 21 as a search target image 33. The image storage portion 22 also has a function of storing the search target image 33 and a search target text on which the search target image 33 is based as a pair (also referred to as a combination) of the search target image 33 and a search target text 35. Here, a plurality of the search target images 33 are collectively referred to as a search target image group 34, and a plurality of the search target texts 35 are collectively referred to as a search target text group 36.

The search target text 35 and the search target image 33 generated on the basis of the search target text 35 are linked and stored in the image storage portion 22. In FIG. 1A, the states of linking are indicated by double-headed arrows. Here, the image generation portion 21 can generate the plurality of search target images 33 from one search target text 35 as described above. Thus, the plurality of search target images 33 can be linked to one search target text 35. FIG. 1A illustrates an example of a state where three search target texts 35 of “aaaaa.”, “bbbbb.”, and “ccccc.” are stored in the image storage portion 22 and three different search target images 33 are linked to the respective search target texts 35.

### [Image Search Portion]

The image search portion 23 has a function of comparing images generated by the image generation portion 21 and specifying the search target text 35 to be presented to the user of the document search device 10 as a search result. For example, the image search portion 23 has a function of calculating the degrees of similarity between the search target images 33 generated from the respective search target texts 35 and a query image. The image search portion 23 has a function of specifying, on the basis of the degrees of similarity, the search target text 35 to be presented to the user of the document search device 10 as a search result. For example, the image search portion 23 has a function of specifying the search target text 35 on which the search target image 33 with a high degree of similarity to a query image is based as the search target text 35 to be presented to the user of the document search device 10.

In this specification and the like, a search target text specified as a text to be presented to the user of the document search device 10 is referred to as an output text. Among images generated on the basis of an output text, an image to be presented to the user of the document search device 10 is referred to as an output image. The image search portion 23 can be regarded as having a function of specifying an output image and an output text.

As described above, the image generation portion 21 can generate a plurality of different images from the same text. Thus, a plurality of output images can be linked to one output text.

As described above, an output image can be the search target image 33 with a high degree of similarity to a query image, for example. An output text can be the search target text 35 on which an output image is based.

### [Output Portion]

The output portion 13 has a function of outputting a search result. Specifically, the output portion 13 has a function of outputting an output text and presenting it to the user of the document search device 10. In the case where a display device (not illustrated) is provided in the document search device 10, for example, the display device can display an output text. The output portion 13 may have a function of reading the search target text 35 with a sound recorded in advance or a synthesized sound. Note that the document search device 10 does not necessarily include the display device. For example, in the case where all of the input portion 11, the document storage portion 20, the image generation portion 21, the image storage portion 22, the image search portion 23, and the output portion 13 are included in a server 130, the display device can be omitted from the document search device 10. At least part of the display device may be included in the output portion 13. Furthermore, part of the display device may be included in the input portion 11.

The output portion 13 can have a function of outputting an output image as well as an output text and presenting the output image to the user of the document search device 10. Specifically, the output portion 13 can have a function of outputting an output image specified from one or more images generated on the basis of an output text and presenting the output image to the user of the document search device 10. The output portion 13 can also have a function of outputting a query text and presenting it to the user of the document search device 10. The output portion 13 can also have a function of outputting one query image or at least one of a plurality of query images generated on the basis of a query text and presenting it to the user of the document search device 10.

Furthermore, the output portion 13 can have a function of outputting information specifying the search target document 31 including an output text and presenting the information to the user of the document search device 10. Examples of the information specifying the search target document 31 are as described above, and ID can be used, for example. The output portion 13 may have a function of outputting the search target document 31 itself including an output text and presenting it to the user of the document search device 10. For example, the output portion 13 may output one or both of a text and a drawing included in the search target document 31 including an output text and present the one or both of the text and the drawing to the user of the document search device 10. In the case where the search target document 31 is a patent application document, for example, at least one of a specification, a drawing, a scope of patent claims, an abstract, and an application may be output and presented to the user of the document search device 10.

As described above, the document search device 10 can generate an image representing a concept represented by a query text and an image representing a concept represented by a search target text, and can present, to the user, an output text specified on the basis of the degree of similarity between these images. Thus, the document search device 10 can search for a document including a text whose concept is similar to but represented differently from a desired concept, and can present the document to the user of the document search device 10. For example, the document search device 10 can search for a document including a text that has a sentence structure, a word or phrase, and the like different from those of a query text but represents a concept similar to that of the query text, and can present the document to the user of the document search device 10.

For example, the document search device 10 can be inhibited from searching for a text that has a sentence structure, a word or phrase, and the like similar to those of a query text but represents a concept different from that of the query text. For example, in the case where one of a query text and the search target text 35 is a positive sentence and the other of the query text and the search target text 35 is a sentence obtained by negating the positive sentence, these sentences have similar sentence structures, words or phrases, and the like but represent opposite concepts, and thus are not similar to each other. For example, in the case where one of a query text and the search target text 35 is “This is a pen.” and the other of the query text and the search target text 35 is “This is not a pen.”, these sentences have similar sentence structures, words or phrases, and the like but represent different concepts. Even in such a case, the document search device 10 can be inhibited from searching for “This is not a pen.” as a text similar to “This is a pen.”

Furthermore, the document search device 10 can search for a document including a text that is written in a language different from that of a query text but represents a concept similar to that of the query text, for example, and can present the document to the user of the document search device 10. Even when a query text is written in English and the search target text 35 is written in a language other than English, for example, the document search device 10 can search for the search target text 35 whose concept is similar to that of the query text and can present the search target text 35 to the user of the document search device 10.

Note that the document search device 10 may have a function of translating one or both of a query text and the search target text 35. For example, the document search device 10 may translate one of a query text and the search target text 35 into the language of the other of the query text and the search target text 35. The translated text can be presented to the user of the document search device 10 by the output portion 13, for example. Translation can be performed by the image search portion 23, for example.

Note that the image search portion 23 may have a function of calculating the degree of similarity between the search target images 33. The degree of similarity can be stored in the image storage portion 22. For example, a combination of the search target images 33 with a high degree of similarity can be stored in the image storage portion 22. In addition, the search target text 35 on which the search target images 33 are based can be linked to the search target images 33 and stored in the image storage portion 22. Thus, in the case where a document designated from the search target documents 31 is used as a query document and at least one search target text 35 designated from the plurality of search target texts 35 included in the query document is used as a query text, an image stored in the image storage portion 22 can be used as a query image. Accordingly, generation of the search target image 33 by the image generation portion 21 can be omitted. The degree of similarity stored in the image storage portion 22 can be used as the degree of similarity between the search target image 33 and the query image; hence, calculation of the degree of similarity by the image search portion 23 can be omitted. In this manner, the time from the input of a query text to the input portion 11 to the output of a search result from the output portion 13 can be shortened.

A recording medium such as a hard disk drive (HDD) or a solid state drive (SSD) can be used as each of the document storage portion 20 and the image storage portion 22, for example. As the document storage portion 20 and the image storage portion 22, different recording media may be used or the same recording medium may be used. In addition, it is possible to use, for each of the document storage portion 20 and the image storage portion 22, a nonvolatile memory such as an ReRAM (Resistive Random Access Memory, also referred to as a resistance-change memory), a PRAM (Phase-change Random Access Memory), an FeRAM (Ferroelectric Random Access Memory), an MRAM (Magnetoresistive Random Access Memory, also referred to as a magneto-resistive memory), a flash memory, a NOSRAM (registered trademark), or a DOSRAM (registered trademark). Furthermore, a volatile memory such as a DRAM (Dynamic Random Access Memory) or an SRAM (Static Random Access Memory) may be provided in each of the document storage portion 20 and the image storage portion 22.

A NOSRAM (registered trademark) is an abbreviation for “Nonvolatile Oxide Semiconductor Random Access Memory (RAM)”. A NOSRAM is a memory in which a memory cell is a 2-transistor (2T) or 3-transistor (3T) type gain cell and each of the transistors is a transistor using a metal oxide in a channel formation region (also referred to as an OS transistor). An OS transistor has an extremely low current that flows between a source and a drain in an off state, that is, an extremely low leakage current. A NOSRAM can be used as a nonvolatile memory by retaining electric charge corresponding to data in memory cells with the use of a characteristic of an extremely low leakage current. In particular, a NOSRAM is capable of reading retained data without destruction (non-destructive reading), and thus is suitable for arithmetic processing in which only data read operations are repeated many times. Stacking and providing a NOSRAM can increase data capacity; thus, a semiconductor device in which a NOSRAM is used for a large-scale cache memory, a large-scale main memory, or a large-scale storage memory can have higher performance.

A DOSRAM (registered trademark) is an abbreviation for “Dynamic Oxide Semiconductor RAM”, which indicates a RAM including a 1T (transistor) 1C (capacitor)-type memory cell. A DOSRAM is a DRAM formed using an OS transistor, and is a memory that temporarily stores information transmitted from the outside. A DOSRAM is a memory utilizing a low off-state current of an OS transistor.

In this specification and the like, a metal oxide is an oxide of a metal in a broad sense. Metal oxides are classified into an oxide insulator, an oxide conductor (including a transparent oxide conductor), an oxide semiconductor (also simply referred to as OS), and the like. For example, in the case where a metal oxide is used in an active layer of a transistor, the metal oxide is referred to as an oxide semiconductor in some cases. That is, in the case where an OS transistor is stated, the OS transistor can also be referred to as a transistor including a metal oxide or an oxide semiconductor.

Examples of a metal oxide used in an OS transistor include indium oxide, gallium oxide, and zinc oxide. The metal oxide preferably contains two or three selected from indium, an element M, and zinc. Note that the element M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium. In particular, the element M is preferably one or more kinds selected from aluminum, gallium, yttrium, and tin.

It is particularly preferable to use an oxide containing indium (In), gallium (Ga), and zinc (Zn) (also referred to as IGZO) as the metal oxide. Alternatively, it is preferable to use an oxide containing indium, tin, and zinc (also referred to as ITZO (registered trademark)). Alternatively, it is preferable to use an oxide containing indium, gallium, tin, and zinc. Alternatively, it is preferable to use an oxide containing indium (In), aluminum (Al), and zinc (Zn) (also referred to as IAZO). Alternatively, it is preferable to use an oxide containing indium (In), aluminum (Al), gallium (Ga), and zinc (Zn) (also referred to as IAGZO). Alternatively, it is preferable to use an oxide containing indium (In), gallium (Ga), zinc (Zn), and tin (Sn) (also referred to as IGZTO).

The image generation portion 21 and the image search portion 23 can each include, for example, a central processing unit (CPU). For example, the document storage portion 20 and the image storage portion 22 may be provided with different CPUs or may share the same CPU. The image generation portion 21 and the image search portion 23 may each include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The image generation portion 21 and the image search portion 23 can each interpret and execute instructions from programs with the use of a processor to process various kinds of data and control programs. The programs that can be executed by the processor are stored in a memory region included in the processor, for example. Note that the image generation portion 21 and the image search portion 23 are collectively referred to as a processing portion.

The image generation portion 21 and the image search portion 23 may each include a main memory. The main memory includes at least one of a volatile memory such as a RAM and a nonvolatile memory such as a ROM (Read Only Memory).

For example, a DRAM, an SRAM, or the like is used as the RAM, and a virtual memory space is assigned and utilized as a working space of the image generation portion 21 and the image search portion 23.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

FIG. 1B is a conceptual diagram illustrating a document search system for enabling the document search device of one embodiment of the present invention.

The document search system illustrated in FIG. 1B includes the server 130 and a terminal 100. Note that the terminal is also referred to as an electronic device. The server 130 and the terminal 100 can communicate via a network 120. Examples E of the network 120 include computer networks such as the Internet, which is an infrastructure of the World Wide Web (WWW), an intranet, an extranet, a PAN (Personal Area Network), a LAN (Local Area Network), a CAN (Campus Area Network), a MAN (Metropolitan Area Network), a WAN (Wide Area Network), and a GAN (Global Area Network). For wireless communication, it is possible to use, as a communication protocol or a communication technology, a communication standard such as the third-generation mobile communication system (3G), the fourth-generation mobile communication system (4G), or the fifth-generation mobile communication system (5G), or a communication standard developed by IEEE such as Wi-Fi (registered trademark) or Bluetooth (registered trademark).

The input portion 11 and the output portion 13 can be provided in the terminal 100, for example. The document storage portion 20, the image generation portion 21, the image storage portion 22, and the image search portion 23 can be provided in the server 130. Note that one or both of the input portion 11 and the output portion 13 may be provided in the server 130. For example, all of the input portion 11, the output portion 13, the document storage portion 20, the image generation portion 21, the image storage portion 22, and the image search portion 23 may be provided in the server 130. The terminal 100 may have any of the functions of the document storage portion 20, the image generation portion 21, the image storage portion 22, and the image search portion 23. Furthermore, for example, one or both of the document storage portion 20 and the image storage portion 22 may be provided in a server different from the server 130 in which the image generation portion 21 and the image search portion 23 are provided. For example, the document storage portion 20 may be provided in a server different from the server 130, and the image storage portion 22 storing data generated by the image generation portion 21 may be provided in the server 130.

In the document search system illustrated in FIG. 1B, the components of the document search device 10 can be provided in the terminal 100 and the server 130, for example. Alternatively, the components of the document search device 10 can be provided in the server 130, but not in the terminal 100.

The server 130 is capable of performing an arithmetic operation using data input from the terminal 100 via the network 120. The server 130 is capable of transmitting an arithmetic operation result to the terminal 100 via the network 120. Accordingly, the burden of the arithmetic operation on the terminal 100 can be reduced.

FIG. 1B illustrates an information terminal 101, an information terminal 103, and an information terminal 107 as the terminal 100. The information terminal 101 is an example of a portable information terminal such as a smartphone. The information terminal 103 is an example of a tablet terminal. When the information terminal 103 is connected to a housing 105 with a keyboard, the information terminal 103 can be used as a laptop information terminal. The information terminal 107 is an example of a desktop information terminal.

With such a structure, a user can access the server 130 from the information terminal 101, the information terminal 103, the information terminal 107, and the like. Then, through the communication via the network 120, the user can receive a service offered by an administrator of the server 130. Examples of the service include a service using the document search device of one embodiment of the present invention.

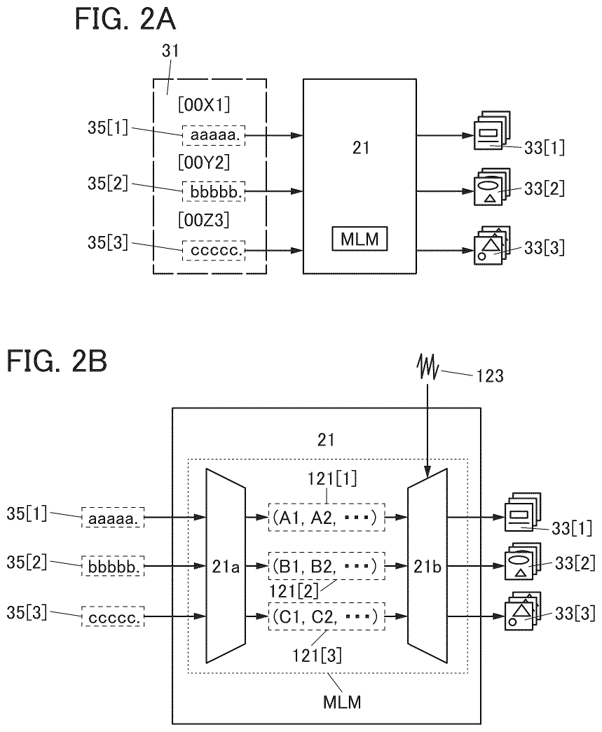

FIG. 2A is a schematic view illustrating generation of the search target image 33. FIG. 2A illustrates an example in which a text “aaaaa.” included in a paragraph [00X1], a text “bbbbb.” included in a paragraph [00Y2], and a text “ccccc.” included in a paragraph [00Z3] of the search target document 31 are respectively used as a search target text 35[1], a search target text 35[2], and a search target text 35[3]. An example is also illustrated in which the image generation portion 21 generates a search target image 33[1] on the basis of the search target text 35[1], generates a search target image 33[2] on the basis of the search target text 35[2], and generates a search target image 33[3] on the basis of the search target text 35[3]. The search target image 33[1] can be an image representing a concept represented by the search target text 35[1], the search target image 33[2] can be an image representing a concept represented by the search target text 35[2], and the search target image 33[3] can be an image representing a concept represented by the search target text 35[3]. Although FIG. 2A illustrates an example in which the search target text 35[1] to the search target text 35[3] each include one paragraph, one embodiment of the present invention is not limited thereto. For example, at least one of the search target text 35[1] to the search target text 35[3] may include two or more paragraphs, e.g., two or more consecutive paragraphs.

In this specification and the like, when a plurality of components are denoted by the same reference numerals, and in particular need to be distinguished from each other, an identification sign such as “[ ]”, “( )”, or “< >” is sometimes added to the reference numerals.

As described above, the image generation portion 21 stores the machine learning model MLM and can generate the search target image 33 using the machine learning model MLM. As described above, the image generation portion 21 can generate a plurality of search target images from one search target text 35. FIG. 2A illustrates an example in which the image generation portion 21 generates three different search target images 33[1] from the search target text 35[1], generates three different search target images 33[2] from the search target text 35[2], and generates three different search target images 33[3] from the search target text 35[3].

In the case where only one search target image 33 is generated from one search target text 35, the search target image 33 does not accurately represent the concept of the search target text 35 in some cases. In view of this, the image generation portion 21 generates the plurality of different search target images 33 from one search target text 35, so that the probability of generating the search target image 33 accurately representing the concept of the search target text 35 can be increased.

FIG. 2B is a schematic view illustrating a structure example of the machine learning model MLM. The machine learning model MLM can have a function of performing an arithmetic operation using an encoder 21a and an arithmetic operation using a decoder 21b.

The encoder 21a has a function of converting an input text into a distributed representation. A vector can be used in the distributed representation. FIG. 2B illustrates an example in which the encoder 21a converts the search target text 35[1] into a distributed representation 121[1] including a component A1 and a component A2, converts the search target text 35[2] into a distributed representation 121[2] including a component Bl and a component B2, and converts the search target text 35[3] into a distributed representation 121[3] including a component C1 and a component C2.

The decoder 21b has a function of converting the distributed representations generated by the encoder 21a into images. Here, noise 123 is added to the decoder 21b, so that the decoder 21b can generate a plurality of different images from the same distributed representation. Specifically, when the noise 123 to be added varies, the decoder 21b can generate a plurality of different images from the same distributed representation. The noise 123 can be generated on the basis of a random number, for example. FIG. 2B illustrates an example in which the decoder 21b generates three different search target images 33[1] from the distributed representation 121[1], generates three different search target images 33[2] from the distributed representation 121[2], and generates three different search target images 33[3] from the distributed representation 121[3].

Described below is learning of the machine learning model MLM stored in the image generation portion 21.

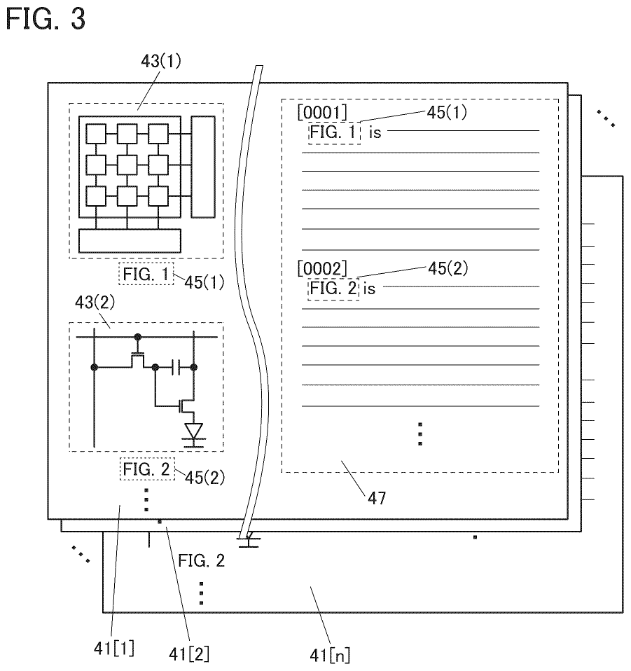

FIG. 3 is a schematic view illustrating a structure example of a learning document 41. FIG. 3 illustrates a learning document 41[1] to a learning document 41[n] (n is an integer greater than or equal to 2).

The learning document 41 includes a learning image 43 and a main text 47. In the case where the learning document 41 is a patent application document, a utility model registration application document, an international application document, or the like, for example, the learning image 43 can be a drawing and the main text 47 can be a specification. An image label 45 is assigned to the learning image 43. As illustrated in FIG. 3, the image label 45 can be a figure number, for example. In addition, the image label 45 may include an alphabet, a Greek character, a Japanese phonetic alphabet, or another character, for example. Furthermore, the image label 45 may include a mark such as ( ). For example, “FIG. 1(a)” can be used as the image label 45.

As the learning document 41, for example, the search target document 31 can be used. For example, some or all of the search target documents 31 included in the search target document group 32 can be used as the learning document 41. A document not included in the search target document 31 may be included in at least part of the learning document 41[1] to the learning document 41[n].

FIG. 3 illustrates a learning image 43(1) and a learning image 43(2) as the learning image 43 included in the learning document 41[1]. An image label 45(1) is assigned to the learning image 43(1), and an image label 45(2) is assigned to the learning image 43(2), for example. That is, one learning document 41 can include a plurality of the learning images 43, and the image label 45 can be assigned to each of the plurality of learning images 43. In the case where FIG. 1 is divided into FIG. 1(a) and FIG. 1(b), for example, FIG. 1(a) and FIG. 1(b) can be different learning images 43, and the image label 45 can be assigned to each of them. That is, “FIG. 1(a)” and “FIG. 1(b)” can be different image labels 45.

The main text 47 includes a text describing the learning image 43. The main text 47 includes the image label 45. Here, the text included in the main text 47 can be divided into a plurality of paragraphs. FIG. 3 illustrates an example in which “FIG. 1” as the image label 45(1) is included in a paragraph [0001] and “FIG. 2” as the image label 45(2) is included in a paragraph [0002] in the main text 47.

In the case where learning of the machine learning model MLM is performed, the image generation portion 21 extracts the text describing the learning image 43 from the main text 47. The extracted text is used as a learning text 49 described later.

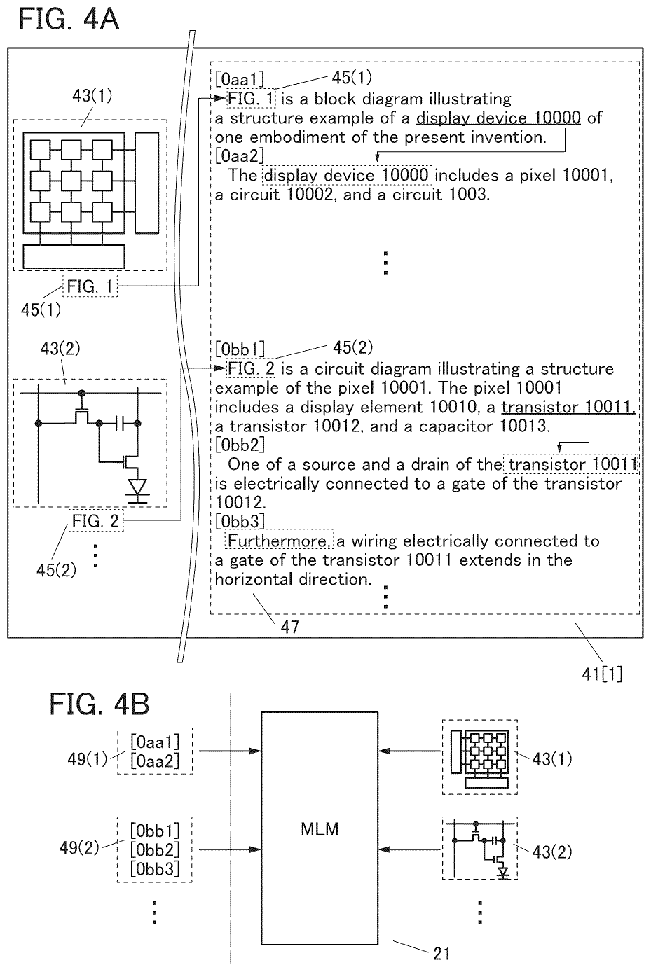

FIG. 4A is a schematic view illustrating an example of a method for obtaining the learning text 49. FIG. 4B is a schematic view illustrating an example of a learning method of the machine learning model MLM. FIG. 4B illustrates specific examples of the learning text 49.

The learning text 49 can be extracted on the basis of the image label 45. For example, at least part of a paragraph including the image label 45 among paragraphs included in the main text 47 can be included in the learning text 49. For another example, a paragraph including a sentence in which the image label 45 is a subject can be included in the learning text 49. For another example, a paragraph including the image label 45 in the first sentence, i.e., the opening sentence, can be included in the learning text 49. For another example, a paragraph including the image label 45 at the beginning can be included in the learning text 49.

In the example illustrated in FIG. 4A, “FIG. 1” as the image label 45(1) is included at the beginning of a paragraph [0aa1]; thus, the paragraph [0aa1] can be included in a learning text 49(1). In addition, “FIG. 2” as the image label 45(2) is included at the beginning of a paragraph [0bb1]; hence, the paragraph [0bb1] can be included in a learning text 49(2). Note that the learning text 49 corresponding to the learning image 43(1) is referred to as the learning text 49(1), and the learning text 49 corresponding to the learning image 43(2) is referred to as the learning text 49(2), for example.

In this specification and the like, a text extracted from the main text 47 on the basis of the image label 45 is referred to as a first learning text in some cases.

The learning text 49 may be extracted on the basis of a word with a reference numeral included in the first learning text. For example, at least part of a paragraph including the word with the reference numeral included in the first learning text may be included in the learning text 49. For another example, a paragraph including a sentence in which the word with the reference numeral included in the first learning text is a subject may be included in the learning text 49. For another example, a paragraph including the word with the reference numeral included in the first learning text in the first sentence, i.e., the opening sentence, may be included in the learning text 49. For another example, a paragraph including the word with the reference numeral included in the first learning text at the beginning may be included in the learning text 49.

In the example illustrated in FIG. 4A, the paragraph [0aa1] that is the first learning text corresponding to the learning image 43(1) includes a word with a reference numeral “display device 10000”. In addition, the paragraph [0bb1] that is the first learning text corresponding to the learning image 43(2) includes a word with a reference numeral “transistor 10011”. Here, for example, “10000” is the reference numeral in the word “display device 10000”, and “10011” is the reference numeral in the word “transistor 10011”. Note that a reference numeral may include an alphabet, a Greek character, a Japanese phonetic alphabet, or another character.

Reference numerals, which are normally described in the drawing, are omitted in the learning image 43 illustrated in FIG. 4A for simplification of the drawing. The same applies to the following drawings illustrating image data.

The beginning of a paragraph [0aa2] includes “display device 10000” that is the word with the reference numeral included in the first learning text corresponding to the learning image 43(1). Thus, the paragraph [0aa2] can be included in the learning text 49(1). The beginning of a paragraph [0bb2] includes “transistor 10011” that is the word with the reference numeral included in the first learning text corresponding to the learning image 43(2). Hence, the paragraph [0bb2] can be included in the learning text 49(2).

In this specification and the like, a text extracted from the main text 47 on the basis of a word with a reference numeral is referred to as a second learning text in some cases.

The learning text 49 may be extracted on the basis of a word with a reference numeral included in the second learning text. For example, the learning text 49 may be extracted on the basis of the word with the reference numeral included in the second learning text by a method similar to the method for extracting the learning text 49 on the basis of the word with the reference numeral included in the first learning text.

For example, at least part of a paragraph including a predetermined word may be included in the learning text 49. For example, a paragraph that includes a conjunctive adverb meaning parallel such as “furthermore” at the beginning and is within a predetermined number of paragraphs from the first learning text or the second learning text may be included in the learning text 49.

In the example illustrated in FIG. 4A, a conjunctive adverb meaning parallel, “furthermore”, is included at the beginning of a paragraph [0bb3]. The paragraph [0bb3] is close to the paragraphs [0bb1] and [0bb2] included in the learning text 49(2) but is away from the paragraph [0aa1] and the paragraph [0aa2] included in the learning text 49(1). Thus, the paragraph [0bb3] can be included in the learning text 49(2).

In this specification and the like, a text extracted from the main text 47 on the basis of a word without a reference numeral such as a conjunctive adverb meaning parallel is referred to as a third learning text in some cases.

The learning text 49 may or may not be extracted on the basis of a word with a reference numeral included in the third learning text. In the case where the learning text 49 is extracted on the basis of the word with the reference numeral included in the third learning text, the extracted text can be included in the second learning text, for example.

By the above-described method, the image generation portion 21 can extract a text describing the learning image 43 from the main text 47 and acquire the learning text 49. As illustrated in FIG. 4B, the paragraph [0aa1] and the paragraph [0aa2] can be used as the learning text 49(1). The paragraph [0bb1] to the paragraph [0bb3] can be used as the learning text 49(2).

In the case where the main text 47 includes a plurality of paragraphs describing the specific learning image 43, consecutive paragraphs among the plurality of paragraphs may be included in one learning text 49. For example, in the case where not only the paragraph [0aa1] and the paragraph [0aa2] but also another paragraph that is away from (is not continuous with) each of the paragraph [0aa1] and the paragraph [0aa2] is a paragraph describing the learning image 43(1), the another paragraph may be included in the learning text 49 different from the learning text 49(1). In that case, a plurality of the learning texts 49 can be linked to one learning image 43. Note that only one paragraph may be allowed to be included in one learning text 49. In that case, a paragraph including the image label 45 at the beginning can be used as the learning text 49, for example. A paragraph in which the image label 45 appears for the first time among paragraphs included in a predetermined range of the main text 47 can be used as the learning text 49. In the case where the main text 47 is a specification, for example, a paragraph in which the image label 45 appears for the first time among paragraphs included in a predetermined section (any of areas separated by headings) can be used as the learning text 49. For example, a paragraph in which the image label 45 appears for the first time among the paragraphs included in “Mode for Carrying Out the Invention” can be used as the learning text 49.

Although the example in which the learning text 49 is extracted for each paragraph is described above, one embodiment of the present invention is not limited thereto. For example, the learning text 49 may be extracted for each sentence included in the main text 47. In that case, for example, when “paragraph” is replaced with “sentence” as appropriate, the above description of the method for extracting the learning text 49 can be referred to. The learning text 49 does not necessarily include the whole sentence, and may include only part of one sentence, for example.

As illustrated in FIG. 4B, the learning of the machine learning model MLM can be performed using the learning text 49 by supervised learning using the learning image 43 as a ground truth label. The learning enables the image generation portion 21 to obtain a weight coefficient, for example. Here, in the case where the plurality of learning texts 49 are linked to one learning image 43, a plurality of learning data sets including different learning texts 49 and one learning image 43 as the ground truth label can be input to the machine learning model MLM. For example, in the case where another paragraph that is away from (is not continuous with) each of the paragraph [0aa1] and the paragraph [0aa2] is a paragraph describing the learning image 43(1) as described in the above example, not only a learning data set including the learning image 43(1) and the learning text 49(1) but also a learning data set including the learning image 43(1) and the learning text 49 representing the another paragraph can be input to the machine learning model MLM. Note that in the case where the machine learning model MLM has the structure illustrated in FIG. 2B, learning of the encoder 21a and learning of the decoder 21b may be performed at the same time or may be performed separately.

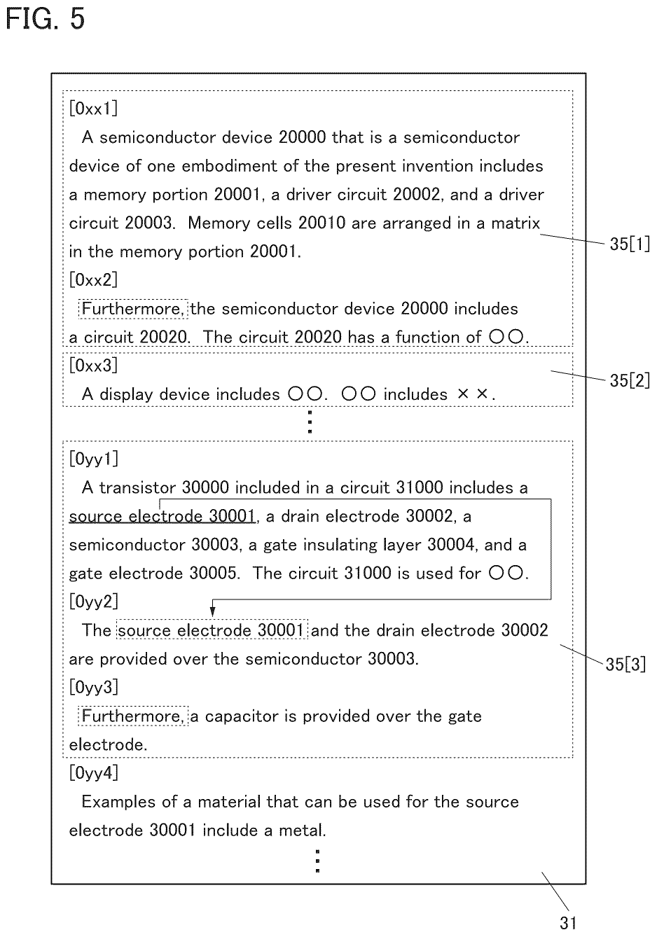

Described below is an example of a method for obtaining the search target text 35. FIG. 5 is a schematic view illustrating an example of the search target document 31. FIG. 5 illustrates a text divided into paragraphs.

For example, one paragraph can be used as one search target text 35. For another example, a plurality of consecutive paragraphs may be included in one search target text 35. For another example, after one paragraph is extracted, other paragraphs are extracted on the basis of the extracted paragraph by methods similar to the above-described method for extracting the second learning text and the above-described method for extracting the third learning text, and these extracted paragraphs can be collectively used as one search target text 35. Note that in the case where one search target text 35 includes a plurality of paragraphs, not all the paragraphs need to be consecutive.

In the example illustrated in FIG. 5, a conjunctive adverb meaning parallel, “furthermore”, is included at the beginning of a paragraph [0xx2]. Thus, the paragraph [0xx2] and the previous paragraph [0xx1] can be included in the same search target text 35. The search target text 35 including the paragraph [0xx1] and the paragraph [0xx2] is referred to as the search target text 35[1].

A paragraph [0xx3] following the paragraph [0xx2] describes a matter different from that of the paragraph [0xx1], the paragraph [0xx2], and the like. Thus, the paragraph [0xx3] is preferably included in the search target text 35 different from the search target text 35 including the paragraph [0xx1 ] and the paragraph [0xx2]. The search target text 35 including the paragraph [0xx3] is referred to as the search target text 35[2].

In the example illustrated in FIG. 5, a paragraph [0yy1] includes a word with a reference numeral “source electrode 30001”. A paragraph [0yy2] following the paragraph [0yy1] also includes “source electrode 30001” at the beginning. In addition, a conjunctive adverb meaning parallel, “furthermore”, is included at the beginning of a paragraph [0yy3] following the paragraph [0yy2]. Accordingly, the paragraph [0yy2] and the paragraph [0yy3] can be included in the same search target text 35 as the paragraph [0yy1]. The search target text 35 including the paragraph [0yy1] to the paragraph [0yy3] is referred to as the search target text 35[3].

Note that some paragraphs are not necessarily extracted as the search target text 35. For example, a paragraph including a predetermined term not suitable for image generation is not necessarily extracted as the search target text 35. In addition, a paragraph composed of only sentences including a predetermined term not suitable for image generation is not necessarily extracted as the search target text 35.

Although the example in which the search target text 35 is extracted for each paragraph is described above, one embodiment of the present invention is not limited thereto. For example, the search target text 35 may be extracted for each sentence included in the search target document 31. In that case, for example, when “paragraph” is replaced with “sentence” as appropriate, the above description of the method for extracting the search target text 35 can be referred to. The search target text 35 does not necessarily include the whole sentence, and may include only part of one sentence, for example.

In the example illustrated in FIG. 5, a paragraph [0yy4] includes a sentence including a term “material”. The paragraph [0yy4] includes no other sentence. Here, in the case where “material” is not suitable for image generation, the paragraph [0yy4] is not necessarily extracted as the search target text 35.

Texts in a predetermined range among the texts included in the search target document 31 may be an extraction target as the search target text 35. In the case where the search target document 31 is a specification of a patent application document, a utility model registration application document, an international application document, or the like, for example, texts included in a predetermined range of the specification may be an extraction target as the search target text 35. For example, texts included in a predetermined section (any of areas separated by headings) of the specification may be an extraction target as the search target text 35. For example, texts included in “Summary of the Invention” in the specification may be an extraction target as the search target text 35. For another example, a specific embodiment or example of the specification may be an extraction target as the search target text 35.

Furthermore, a text with a low degree of similarity to the learning text 49 among the texts included in the search target document 31 is not necessarily included in the search target text 35. For example, a text whose degree of similarity to the learning text 49 is lower than or equal to a predetermined value is not necessarily included in the search target text 35. This can inhibit the image search portion 23 from generating the search target image 33 that does not represent a concept represented by the search target text 35.

Although FIG. 5 illustrates the example in which the search target text 35 is extracted from a specification of a patent application document, a utility model registration application document, an international application document, or the like, one embodiment of the present invention is not limited thereto. For example, the search target text 35 may be extracted from the scope of patent claims, the scope of claims for utility model registration, or the scope of claims.

### <Example of Document Search Method>

An example of a document search method using the document search device 10 will be described below.

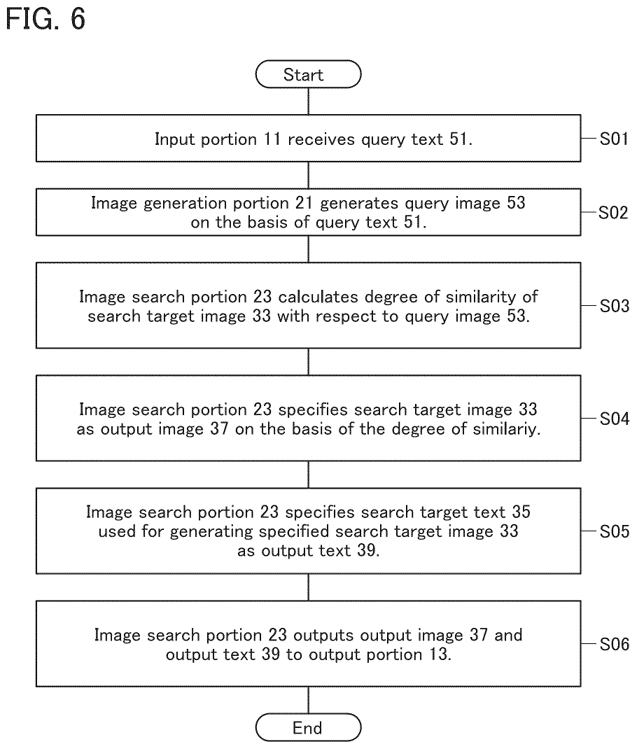

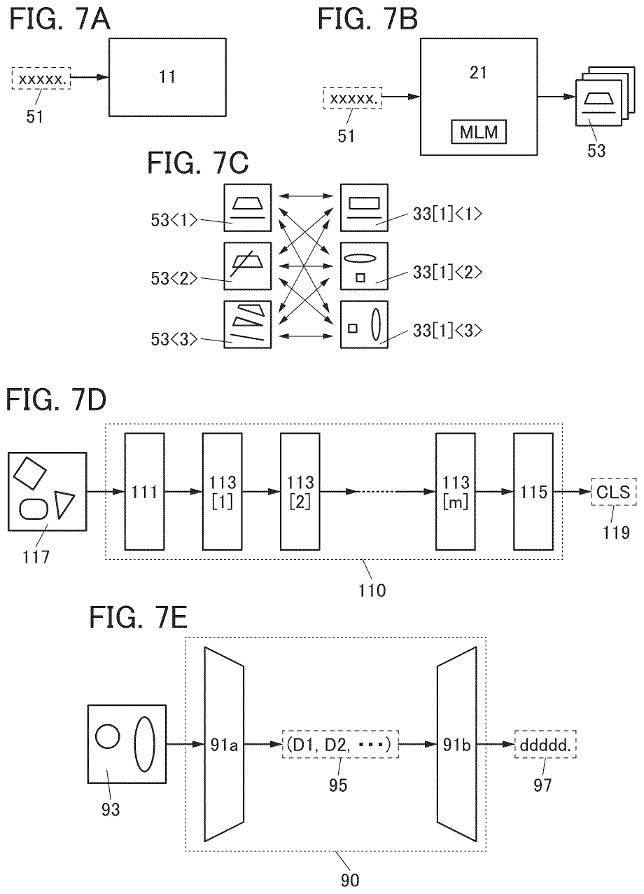

FIG. 6 is a flowchart showing the example of the document search method. First, in Step S01, the input portion 11 receives a query text 51 that is a text including a content that the user desires to search for. FIG. 7A is a schematic view illustrating a state where the query text 51 is input to the input portion 11 in Step S01. In the example illustrated in FIG. 7A, the query text 51 is “xxxxx.”

For example, the user of the document search device 10 can designate one or more paragraphs included in a query document as the query text 51. The user of the document search device 10 can designate one or more sentences included in the query document as the query text 51. The user of the document search device 10 can designate part of a paragraph or a sentence as the query text 51. In the case where the query document is a patent application document, a utility model registration application document, or an international application document, for example, the query text 51 can be a text included in a specification, as described above.

Here, the query document is preferably a document of the same type as the search target document 31. For example, in the case where the query document is a patent application document, a utility model registration application document, or an international application document, the search target document 31 is preferably also a patent application document, a utility model registration application document, or an international application document. As described above, the query document can be a document designated from the search target documents 31 by the user of the document search device 10. In that case, the user can specify the query document by designating information specifying the document. For example, the user of the document search device 10 can specify the query document by designating ID. In the case where a document designated from the search target documents 31 is used as the query document, at least one search target text 35 designated from the plurality of search target texts 35 included in the query document can be used as the query text 51.

Note that a query document is not necessarily the search target document 31 as described above. For example, a document input to the input portion 11 by the user of the document search device 10 may be used as a query document. Then, the user of the document search device 10 can designate at least part of a text included in the query document as the query text 51. A document is not necessarily input to the input portion 11. In that case, for example, the user of the document search device 10 can input a given text to the input portion 11 and the text can be used as the query text 51.

Next, in Step S02, the image generation portion 21 generates a query image 53 on the basis of the query text 51. FIG. 7B is a schematic view illustrating a state where the image generation portion 21 generates the query image 53 in Step S02.

As illustrated in FIG. 7B, the image generation portion 21 stores the learned machine learning model MLM, and can generate the query image 53 representing a concept represented by the query text 51 with the use of the machine learning model MLM. The image generation portion 21 can generate a plurality of different query images 53. This can increase the probability of generating the query image 53 accurately representing the concept of the query text 51. FIG. 7B illustrates an example in which the image generation portion 21 generates three query images 53.

As described above, the machine learning model MLM can have the structure illustrated in FIG. 2B, for example. In that case, after the encoder 21a generates a distributed representation on the basis of the query text 51, the decoder 21b can generate the query image 53 on the basis of the distributed representation. Here, the noise 123 is added to the decoder 21b, so that the decoder 21b can generate the plurality of different query images 53 from one distributed representation based on the query text 51.

A paragraph, a sentence, or the like around the paragraph, the sentence, or the like designated by the user of the document search device 10 may be extracted by the image generation portion 21 and included in the query text 51 used for generating the query image 53. The paragraph, the sentence, or the like to be included in the query text 51 may be extracted by a method similar to the method for extracting the search target text 35 shown in FIG. 5, for example. That is, the paragraph, the sentence, or the like to be included in the query text 51 may be extracted by methods similar to the above-described method for extracting the second learning text and the above-described method for extracting the third learning text.

Next, in Step S03, the image search portion 23 calculates the degree of similarity between the search target image 33 and the query image 53. Specifically, the image search portion 23 calculates the degrees of similarity between the plurality of search target images 33 generated on the basis of the plurality of search target texts 35 included in each of the search target documents 31 in the search target document group 32 and each of the plurality of query images 53, for example.

FIG. 7C is a schematic view illustrating calculation of the degree of similarity, and specifically illustrates calculation of the degree of similarity between the search target image 33[1] illustrated in FIG. 2A and FIG. 2B and the query image 53. FIG. 7C illustrates three query images 53 of a query image 53<1>, a query image 53<2>, and a query image 53<3>. FIG. 7C also illustrates three search target images 33[1] of a search target image 33[1]<1>, a search target image 33[1]<2>, and a search target image 33[1]<3>. In FIG. 7C, the degrees of similarity between the query images 53 and the search target images 33[1] indicated by double-headed arrows are calculated.

In the example illustrated in FIG. 7C, the degrees of similarity between the search target image 33[1]<1> to the search target image 33[1]<3> and each of the query image 53<1>, the query image 53<2>, and the query image 53<3> are calculated. That is, nine degrees of similarity are calculated in the example illustrated in FIG. 7C. The highest degree of similarity among the nine degrees of similarity can be used as the degree of similarity between the search target image 33[1] and the query image 53. The degrees of similarity between the search target images 33 other than the search target image 33[1], such as the search target image 33[2] and the search target image 33[3], and the query image 53 can be calculated in a similar manner. Note that the average value or the median value of the nine degrees of similarity may be used as the degree of similarity between the search target image 33[1] and the query image 53, for example. Alternatively, an array storing the nine degrees of similarity may be used.

In this manner, the image search portion 23 can obtain the degree of similarity between the search target image 33 accurately representing the concept represented by the search target text 35 and the query image 53 accurately representing the concept represented by the query text 51. In the example illustrated in FIG. 7C, the image search portion 23 can obtain the degree of similarity between the search target image 33[1] accurately representing the concept represented by the search target text 35[1] illustrated in FIG. 2A and FIG. 2B and the query image 53 accurately representing the concept represented by the query text 51. Accordingly, the document search device 10 can search for the search target document 31 including the search target text 35 whose concept is similar to that of the query text 51 with higher accuracy, and can present the search target document 31 to the user of the document search device 10.

The image search portion 23 generates a first distributed representation from the query image 53 and generates a second distributed representation from the search target image 33, for example, and then the degree of similarity between the search target image 33 and the query image 53 can be calculated on the basis of the first distributed representation and the second distributed representation. Specifically, for example, the image search portion 23 generates the first distributed representation from each of the plurality of query images 53 and generates the second distributed representation from each of the plurality of search target images 33. After that, the degree of similarity between the first distributed representation and the second distributed representation is calculated, and the degree of similarity can be used as the degree of similarity between the search target image 33 and the query image 53.

The first distributed representation and the second distributed representation can be generated using a neural network model, for example, and specifically, can be generated using an image classification model or an image caption generation model.

FIG. 7D is a schematic view illustrating a structure example of an image classification model 110. The image classification model 110 can include an input layer 111, an intermediate layer 113[1] to an intermediate layer 113[m] (m is an integer greater than or equal to 1), and an output layer 115.

In a neural network model including an input layer, a plurality of intermediate layers, and an output layer in this specification and the like, the intermediate layer close to the input layer is referred to as a shallow intermediate layer, and the intermediate layer close to the output layer is referred to as a deep intermediate layer. For example, a larger number in [ ] of the intermediate layer 113[1] to the intermediate layer 113[m] included in the image classification model 110 means a deeper intermediate layer 113.

In the image classification model 110, when an image 117 is input to the input layer 111, arithmetic operations are performed by the intermediate layer 113[1] to the intermediate layer 113[m], and a classification 119 is output from the output layer 115. In FIG. 7D, the classification 119 of the image 117 is denoted as “CLS”.

In the image classification model 110, a value (vector) output from any of the intermediate layer 113[1] to the intermediate layer 113[m] can be used as the first distributed representation or the second distributed representation. Specifically, in the case where the image 117 is the query image 53, the value (vector) can be used as the first distributed representation. In the case where the image 117 is the search target image 33, the value (vector) can be used as the second distributed representation.

The learning of the image classification model 110 can be performed by supervised learning using an image annotated with a classification (an image in which a classification is used as a ground truth label). For example, a convolutional neural network (CNN) can be used as the image classification model 110. Specifically, for example, AlexNet, VGG, GoogLeNet, ResNet, DenseNet, or MobileNet can be used as the image classification model 110. Here, in the case where a CNN is used as the image classification model 110, the intermediate layer 113[1] to the intermediate layer 113[m] can each be a convolutional layer, a pooling layer, or a fully-connected layer.

An image caption generation model refers to a model that generates a text describing an input image. FIG. 7E is a schematic view illustrating a structure example of an image caption generation model 90. The image caption generation model 90 can have a function of performing an arithmetic operation using an encoder 91a and an arithmetic operation using a decoder 91b.

The encoder 91a has a function of converting an image 93 input to the image caption generation model 90 into a distributed representation 95. FIG. 7E illustrates an example in which the encoder 91a converts the image 93 into the distributed representation 95 including a component DI and a component D2. As the encoder 91a, a CNN can be used, for example.

The decoder 91b has a function of converting the distributed representation 95 into a text 97. The text 97 can be one or more sentences describing a concept represented by the image 93, for example. As the decoder 91b, a recurrent neural network (RNN) or a long short-term memory (LSTM) can be used, for example. FIG. 7E illustrates an example in which the text 97 is “ddddd.”

In the case where the image caption generation model 90 is used for generating the first distributed representation and the second distributed representation, the distributed representation 95 can be used as the first distributed representation or the second distributed representation. Specifically, in the case where the image 93 is the query image 53, the distributed representation 95 can be used as the first distributed representation, and in the case where the image 93 is the search target image 33, the distributed representation 95 can be used as the second distributed representation.

Cosine similarity can be used as the degree of similarity between the first distributed representation and the second distributed representation, for example. As the degree of similarity between the first distributed representation and the second distributed representation, for example, the distance such as the Euclidean distance, the Mahalanobis distance, the Manhattan distance, the Chebyshev distance, or the Minkowski distance may be used, or a reciprocal of any of these distances may be used.

Note that the degree of similarity between the search target image 33 and the query image 53 may be calculated without using a distributed representation. For example, the degree of similarity may be calculated by comparison between a pixel value of the search target image 33 and a pixel value of the query image 53. As the pixel value, an RGB value, an HSV value, or an HLS value may be used, for example. The degree of similarity may be calculated by comparison between a histogram of the luminance of the search target image 33 and a histogram of the luminance of the query image 53. The degree of similarity may be calculated using feature point matching. The feature point matching can be performed using AKAZE or ORB, for example.

There is no need to calculate the degrees of similarity between all the search target images 33 and the query image 53 in Step S03. For example, the degree of similarity between only the search target image 33 selected on the basis of a first classification as the classification of the query images 53 and a second classification as the classification of the search target images 33 and the query image 53 may be calculated. Specifically, for example, the image search portion 23 classifies the query images 53 as the first classification and classifies the plurality of search target images 33 as the second classification. After that, the degree of similarity between the search target image 33 selected from the plurality of search target images 33 on the basis of the first classification and the second classification and the query image 53 can be calculated. For example, the degree of similarity between the search target image 33 in which the second classification is the same as or similar to the first classification and the query image 53 can be calculated.

The query images 53 and the search target images 33 can be classified using the above-described image classification model, for example. In addition to the classification using the image classification model, the query images 53 may be classified using a classification given to a query document, and the search target images 33 may be classified using a classification given to the search target document 31. In the case where the query document and the search target document 31 are each a patent application document, for example, the query images 53 and the search target images 33 may be classified using a patent classification in addition to the classification using the image classification model.

In Step S03, the degree of similarity between only the search target image 33 selected on the basis of a third classification as the classification of the query texts 51 and a fourth classification as the classification of the search target texts 35 and the query image 53 may be calculated. Specifically, for example, the image search portion 23 classifies the query texts 51 as the third classification and classifies the plurality of search target texts 35 as the fourth classification. After that, the degree of similarity between the search target image 33 selected from the plurality of search target images 33 on the basis of the third classification and the fourth classification and the query image 53 can be calculated. For example, the degree of similarity between the search target image 33 generated from the search target text 35 in which the fourth classification is the same as or similar to the third classification and the query image 53 can be calculated.

The query texts 51 and the search target texts 35 can be classified by, for example, a text classification model that is a combination of a first model similar to the encoder 21a illustrated in FIG. 2B and a second model similar to a classification model such as the above-described image classification model. For example, distributed representations of the query texts 51 are generated using the first model and the distributed representations are input to intermediate layers of the second model, so that the third classification can be obtained. For example, distributed representations of the search target texts 35 are generated using the first model and the distributed representations are input to the intermediate layers of the second model, so that the fourth classification can be obtained.

A model used for a purpose other than a text classification can be used also as the first model and the second model. For example, the encoder 21a used in the machine learning model MLM that is an image generation model can be used also as the first model. In addition, the intermediate layer 113[i] (i is an integer greater than or equal to 1 and less than or equal to m) to the intermediate layer 113[m] and the output layer 115 of the image classification model 110 used for calculating the degree of similarity between the search target image 33 and the query image 53 can be used also for the second model.

As the first model and the second model included in the text classification model, dedicated models may be used instead of the above-described models. In that case, the learning of the text classification model can be performed by supervised learning using a text annotated with a classification (a text in which a classification is used as a ground truth label). As the text classification model, BERT can be used, for example.

In addition to the classification using the text classification model, the query texts 51 may be classified using a classification given to a query document, and the search target texts 35 may be classified using a classification given to the search target document 31. In the case where the query document and the search target document 31 are each a patent application document, for example, the query texts 51 and the search target texts 35 may be classified using a patent classification in addition to the classification using the text classification model.

As described above, with the document search method of one embodiment of the present invention, the degree of similarity between only the search target image 33 selected on the basis of the first classification and the second classification or the third classification and the fourth classification and the query image 53 can be calculated. This can inhibit the search target text 35 whose field is different from that of the query text 51 and the search target image 33 whose field is different from that of the query image 53 from being presented to the user of the document search device 10 as search results, for example. Accordingly, a highly convenient document search device and a highly convenient document search method can be achieved.

Next, in Step S04, the image search portion 23 specifies at least one of the plurality of search target images 33 on the basis of the degree of similarity calculated in Step S03. The specified search target image 33 is referred to as an output image 37. The output image 37 can be, for example, the search target image 33 with a high degree of similarity to the query image 53. For example, the search target image 33 whose degree of similarity is higher than or equal to a predetermined value can be used as the output image 37. For another example, a predetermined number of search target images 33 counted from one with the highest degree of similarity can be used as the output image 37.

Note that in addition to the search target image 33 specified by the above-described method, other search target images 33 generated on the basis of the search target text 35 on which the search target image 33 is based may be included in the output image 37. For example, in the case where the search target image 33[1]<1> illustrated in FIG. 7C is specified by the above-described method, not only the search target image 33[1]<1> but also the search target image 33[1]<2> and the search target image 33[1]<3> may be included in the output image 37.

Next, in Step S05, the image search portion 23 specifies the search target text 35 used for generating the specified search target image 33. That is, the image search portion 23 specifies the search target text 35 used for generating the output image 37. The specified search target text 35 is referred to as an output text 39. Accordingly, the output text 39 is the search target text 35 on which the output image 37 is based.

Next, in Step S06, the image search portion 23 outputs the output image 37 and the output text 39 to the output portion 13. Thus, the output portion 13 can output the output image 37 and the output text 39 and present them to the user of the document search device 10. Hence, the output portion 13 can output search results and present them to the user of the document search device 10. For example, the search results can be displayed on the display device included in the document search device 10. In the case where the output image 37 does not need to be presented to the user of the document search device 10, the image search portion 23 does not necessarily output the output image 37 to the output portion 13. The above is the example of the document search method of one embodiment of the present invention.

Note that the degree of similarity between the search target images 33 may be calculated in advance by the image search portion 23 and may be stored in the image storage portion 22. For example, a combination of the search target images 33 with a high degree of similarity may be stored in the image storage portion 22. In addition, the search target text 35 on which the search target images 33 are based may be linked to the search target images 33 and stored in the image storage portion 22. Thus, in the case where a document designated from the search target documents 31 is used as a query document and a text designated from the search target texts 35 included in the query document is used as the query text 51, the query image 53 can be an image stored in the image storage portion 22. Hence, Step S02 can be omitted. Since the degree of similarity stored in the image storage portion 22 can be used as the degrees of similarity between the search target images 33 and the query image 53, Step S03 can be omitted. Accordingly, the time taken from Step S01 to Step S06 can be shortened.

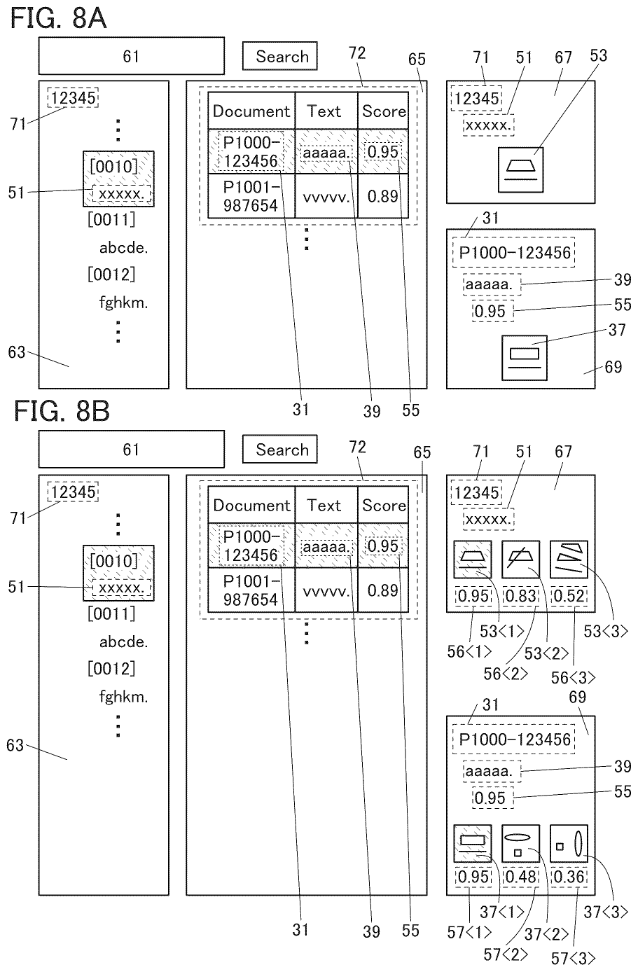

FIG. 8A is a schematic view illustrating an example of a display mode of search results, and illustrates an example of a screen layout of the display device included in the document search device 10, for example. FIG. 8A is also regarded as an example of a GUI (Graphical User Interface).

In the example illustrated in FIG. 8A, an input field 61 is displayed. One or more pieces of information specifying a query document, for example, can be input to the input field 61. For example, ID given to a document can be input. For another example, one or more of a title given to a document, the date such as an issue date of the document, a creator of the document, a publisher, a text included in the document, and the like can be input. For another example, in the case where a query document is a published patent application, one or more of an application management number for identifying an application (including an internal unique number), an application family management number for identifying an application family, an application number, a publication number, a registration number, an inventor, an applicant, a drawing, an abstract, an application date, a priority date, a publication date, a status, a patent classification, a category, a keyword, and the like can be input. Note that the query text 51 may be directly input to the input field 61.

When the user of the document search device 10 inputs information specifying a query document to the input field 61 and then selects a “Search” button, the query document is displayed on a region 63. The “Search” button can be selected using an input device. The “Search” button may be selected by a click or touch of the “Search” button, or may be selected using a keyboard, for example.

Here, in the case where the query document includes a text and a drawing, only the text may be displayed on the region 63 or the text and the drawing may be displayed on the region 63. In the case where the query document is a patent application document, a utility model registration application document, or an international application document, for example, a specification may be displayed on the region 63 or the specification and a drawing may be displayed on the region 63. FIG. 8A illustrates an example in which ID 71 of the query document and the text included in the query document are displayed on the region 63. Specifically, in FIG. 8A, the ID 71 is “12345”, a paragraph [0010] includes “xxxxx.”, a paragraph [0011] includes “abcde.”, and a paragraph [0012] includes “fghkm.”

Here, the text included in the query document can be divided into units each of which can be specified as the query text 51 to be displayed on the region 63. For example, in the case where one or more paragraphs included in the query document can be specified as the query text 51, the text included in the query document can be divided into paragraphs to be displayed on the region 63. For another example, in the case where one or more sentences included in the query document can be specified as the query text 51, the text included in the query document can be divided into sentences to be displayed on the region 63. For example, a line break can be inserted for each sentence to be displayed.

In the case where the user of the document search device 10 directly inputs the query text 51 to the input field 61, the query text 51 can be displayed on the region 63. Note that the user of the document search device 10 may be allowed to directly input the query text 51 to the region 63.

The user of the document search device 10 can designate the query text 51 by designating at least part of the text displayed on the region 63. The query text 51 can be designated using an input device. The query text 51 may be designated by, for example, a click or touch of the divided unit of the text displayed on the region 63, or may be designated using a keyboard. For example, in the case where the text included in the query document is divided into paragraphs and displayed on the region 63, a paragraph is clicked or touched so that the paragraph can be designated as the query text 51.

In the region 63, the query text 51 can be highlighted. FIG. 8A illustrates an example in which the paragraph [0010] is designated as the query text 51 and highlighted.

A region 65 displays the output text 39, the search target document 31 including the output text 39, and a degree of similarity 55 between the output image 37 generated on the basis of the output text 39 and the query image 53. FIG. 8A illustrates an example in which the region 65 displays a table 72 including a “Document” field, a “Text” field, and a “Score” field.

In the “Document” field in the table 72, the search target document 31, specifically information specifying the search target document 31, is displayed. In the “Text” field, the output text 39 is displayed. In the “Score” field, the degree of similarity 55 is displayed. FIG. 8A illustrates an example in which the output text 39 included in the search target document 31 specified by the document number “P1000-123456” is the text “aaaaa.” and the score of the degree of similarity 55 between the output image 37 generated on the basis of the text “aaaaa.” and the query image 53 is “0.95”. FIG. 8A also illustrates an example in which the output text 39 included in the search target document 31 specified by the document number “P1001-987654” is a text “vvvvv.” and the degree of similarity 55 between the output image 37 generated on the basis of the text “vvvvv.” and the query image 53 is 0.89.

As described above, in the case where the image generation portion 21 generates the plurality of query images 53 and generates the plurality of search target images 33 from the same search target text 35, the image search portion 23 calculates the degrees of similarity between the plurality of search target images 33 and each of the plurality of query images 53. In that case, the highest degree of similarity among the plurality of degrees of similarity can be used as the degree of similarity 55. Note that the average value or the median value of the plurality of degrees of similarity may be used as the degree of similarity 55, for example.

In the region 65, the items in the table 72 can be sorted according to “Score” and displayed, for example. That is, the items can be displayed in descending order of the degree of similarity 55. Note that the items may be sorted according to “Document” or “Text” and displayed. In the case where the items are sorted according to “Document”, the items can be displayed in the order of the document number, for example.

In the table 72, “Document” and “Score” can be displayed for each “Text”. Thus, in the case where a plurality of the output texts 39 are included in the same search target document 31, a plurality of the same search target documents 31 are displayed in the table 72. For example, in the case where the search target document 31 specified by the document number “P1000-123456” includes not only the output text 39 including the text “aaaaa.” but also another output text 39, the document number “P1000-123456” appears a plurality of times in the “Document” field in the table 72. Note that the “Text” field and the “Score” field may be collectively displayed for each search target document 31.

The user of the document search device 10 can designate at least one of the output texts 39 included in the “Text” field of the table 72. The output text 39 can be designated using an input device. The output text 39 may be designated by, for example, a click or touch of a row in the table 72, or may be designated using a keyboard. The designated output text 39 can be highlighted. The search target document 31 including the designated output text 39 and the degree of similarity 55 can also be designated and highlighted. FIG. 8A illustrates an example in which the document number “P1000-123456”, the text “aaaaa.”, and the score “0.95” are designated and highlighted.

A region 67 can display the ID 71 specifying the query document, the query text 51, and the query image 53. FIG. 8A illustrates an example in which the region 67 displays “12345” as the ID 71 and “xxxxx.” as the query text 51. FIG. 8A also illustrates an example in which the region 67 displays the query image 53 used for calculating the designated degree of similarity 55.

A region 69 can display the designated search target document 31, the designated output text 39, and the designated degree of similarity 55. For example, the region 69 can display the search target document 31 by displaying information specifying the search target document 31. The region 69 can also display the output image 37 generated on the basis of the designated output text 39. FIG. 8A illustrates an example in which the region 69 displays the document number “P1000-123456” as the search target document 31, the text “aaaaa.” as the output text 39, and the score “0.95” as the degree of similarity 55. FIG. 8A also illustrates an example in which the region 69 displays the output image 37 used for calculating the designated degree of similarity 55.

Note that, for example, the region 69 may display the search target document 31 itself including the designated output text 39. For example, the region 69 may display one or both of a text and a drawing included in the search target document 31 including the designated output text 39. In the case where the search target document 31 is a patent application document, for example, the region 69 may display at least one of a specification, a drawing, a scope of patent claims, an abstract, and an application.

When the region 67 displays the query text 51, the query image 53, and the like and the region 69 displays the output text 39 and the output image 37, the user of the document search device 10 can easily know whether the search result is a desired one. For example, the user of the document search device 10 can know whether the search result is a desired one more easily than the case where the region 67 does not display the query image 53 and the region 69 does not display the output image 37. In the above manner, a highly convenient document search device and a highly convenient document search method can be achieved. Note that in the case where display of the query image 53 is unnecessary, the region 67 does not necessarily display the query image 53. In the case where display of the output image 37 is unnecessary, the region 69 does not necessarily display the output image 37.

FIG. 8B is a modification example of the screen layout illustrated in FIG. 8A, and illustrates an example in which the region 67 displays the plurality of query images 53 and the region 69 displays a plurality of the output images 37. For example, the region 67 can display all the query images 53. For example, the region 69 can display, as the output images 37, all the search target images 33 generated on the basis of the output text 39 designated by the user of the document search device 10. FIG. 8B illustrates an example in which the region 67 displays the query image 53<1>, the query image 53<2>, and the query image 53<3>, and the region 69 displays an output image 37<1>, an output image 37<2>, and an output image 37<3>.

FIG. 8B illustrates an example in which a degree of similarity 56<1> is displayed under the query image 53<1>, a degree of similarity 56<2> is displayed under the query image 53<2>, and a degree of similarity 56<3> is displayed under the query image 53<3>. The degree of similarity 56 can be the degree of similarity between any of the plurality of output images 37, e.g., all the output images 37, displayed on the region 69 and the query image 53. For example, the highest degree of similarity can be used. Note that the degree of similarity 56 may be, for example, the average value or the median value of the degrees of similarity between the plurality of output images 37, e.g., all the output images 37, displayed on the region 69 and the query image 53.

Specifically, the degree of similarity 56<1> can be the degree of similarity between any of the output image 37<1> to the output image 37<3> and the query image 53<1> and can be, for example, the highest degree of similarity. Similarly, the degree of similarity 56<2> can be the degree of similarity between any of the output image 37<1> to the output image 37<3> and the query image 53<2> and can be, for example, the highest degree of similarity. The degree of similarity 56<3> can be the degree of similarity between any of the output image 37<1> to the output image 37<3> and the query image 53<3> and can be, for example, the highest degree of similarity. Note that the degree of similarity 56<1> may be the average value or the median value of the degrees of similarity between the output image 37<1> to the output image 37<3> and the query image 53<1>. Similarly, the degree of similarity 56<2> may be the average value or the median value of the degrees of similarity between the output image 37<1> to the output image 37<3> and the query image 53<2>. The degree of similarity 56<3> may be the average value or the median value of the degrees of similarity between the output image 37<1> to the output image 37<3> and the query image 53<3>.

FIG. 8B illustrates an example in which a degree of similarity 57<1> is displayed under the output image 37<1>, a degree of similarity 57<2> is displayed under the output image 37<2>, and a degree of similarity 57<3> is displayed under the output image 37<3>. The degree of similarity 57 can be the degree of similarity between the output image 37 displayed on the region 69 and any of the plurality of query images 53, e.g., all the query images 53. For example, the highest degree of similarity can be used. Note that the degree of similarity 57 may be the average value or the median value of the degrees of similarity between the output image 37 displayed on the region 69 and the plurality of query images 53, e.g., all the query images 53.

Specifically, the degree of similarity 57<1> can be the degree of similarity between the output image 37<1> and any of the query image 53<1> to the query image 53<3> and can be, for example, the highest degree of similarity. Similarly, the degree of similarity 57<2> can be the degree of similarity between the output image 37<2> and any of the query image 53<1> to the query image 53<3> and can be, for example, the highest degree of similarity. The degree of similarity 57<3> can be the degree of similarity between the output image 37<3> and any of the query image 53<1> to the query image 53<3> and can be, for example, the highest degree of similarity. Note that the degree of similarity 57<1> may be the average value or the median value of the degrees of similarity between the output image 37<1> and the query image 53<1> to the query image 53<3>, for example. Similarly, the degree of similarity 57<2> may be the average value or the median value of the degrees of similarity between the output image 37<2> and the query image 53<1> to the query image 53<3>, for example. The degree of similarity 57<3> may be the average value or the median value of the degrees of similarity between the output image 37<3> and the query image 53<1> to the query image 53<3>, for example.

The document search device 10 preferably performs display such that the user can recognize the query image 53 and the output image 37 used for calculating the degree of similarity 55. FIG. 8B illustrates an example in which the query image 53<1> and the output image 37<1> are used for calculating the degree of similarity 55. In the example illustrated in FIG. 8B, the query image 53<1> and the output image 37<1> are highlighted so that the user of the document search device 10 can know the use of these images for the calculation of the degree of similarity 55.

Note that one of the query image 53 and the output image 37 may be displayed as a single image as illustrated in FIG. 8A, and the other of the query image 53 and the output image 37 may be displayed as multiple images as illustrated in FIG. 8B. One or both of the degree of similarity 56 and the degree of similarity 57 are not necessarily displayed. For example, in the case where the query image 53 is designated, the degree of similarity 56 of the designated query image 53 may be displayed, or in the case where the output image 37 is designated, the degree of similarity 57 of the designated output image 37 may be displayed. The query image 53 and the output image 37 can be designated using an input device. The query image 53 and the output image 37 may be designated by, for example, a click or touch of the query image 53 and the output image 37, or may be designated using a keyboard.

With the above-described document search method of one embodiment of the present invention, an image representing a concept represented by the query text 51 and an image representing a concept represented by the search target text 35 can be generated, and the output text 39 specified on the basis of the degree of similarity between these images can be presented to the user. Thus, it is possible to search for a document including a text whose concept is similar to but represented differently from a desired concept and to display the document on the display device included in the document search device 10, for example. With the document search method of one embodiment of the present invention, for example, it is possible to search for a document including a text having a sentence structure, a word or phrase, and the like different from those of a query text but representing a concept similar to that of the query text and to display the document on the display device included in the document search device 10. With the document search method of one embodiment of the present invention, for example, it is possible to inhibit searching for a text having a sentence structure, a word or phrase, and the like similar to those of a query text but representing a concept different from that of the query text, as described above.

Furthermore, with the document search method of one embodiment of the present invention, it is possible to search for a document including a text that is written in a language different from that of a query text but represents a concept similar to that of the query text and to display the document on the display device included in the document search device 10, for example. With the document search method of one embodiment of the present invention, even when the query text 51 is written in English and the search target text 35 is written in a language other than English, for example, it is possible to search for the search target text 35 whose concept is similar to that of the query text 51 and to display the search target text 35 as the output text 39 on the display device included in the document search device 10.

Note that in the document search method of one embodiment of the present invention, the document search device 10 may translate one or both of the query text 51 and the search target text 35. For example, the document search device 10 may translate one of the query text 51 and the search target text 35 into the language of the other of the query text 51 and the search target text 35. For example, after the output text 39 is specified in Step S05, the document search device 10 may translate the output text 39 into the language of the query text 51. The translated text can be displayed on the display device included in the document search device 10, for example. In the case where the output text 39 is translated, for example, the translated text can be displayed on the region 69. In the case where the query text 51 is translated, the translated text can be displayed on one or both of the region 63 and the region 67. Translation can be performed by the image search portion 23 as described above, for example.

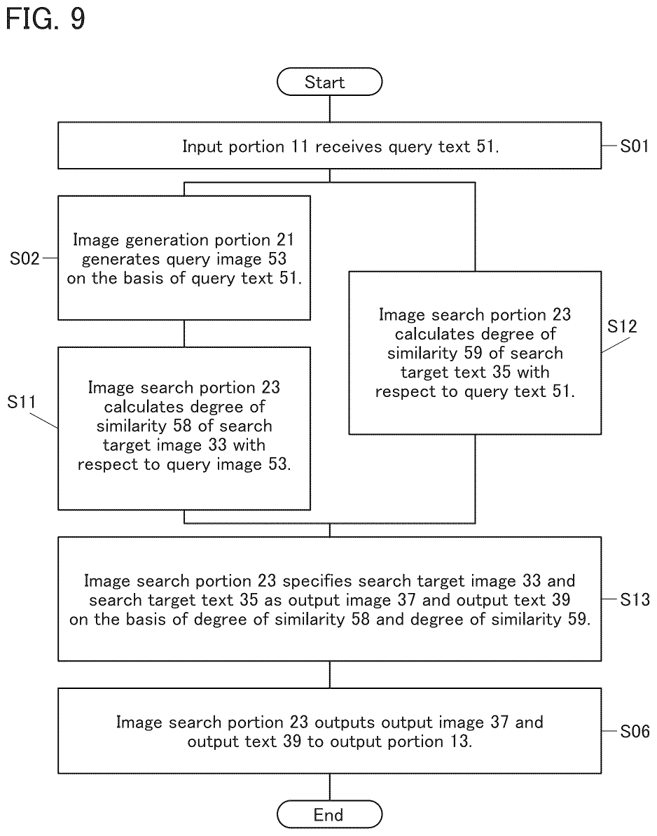

FIG. 9 is a flowchart showing an example of a document search method, which is different from the document search method in FIG. 6. In the document search method shown in FIG. 9, first, the input portion 11 receives the query text 51 as in Step S01 shown in FIG. 6. Next, as in Step S02 shown in FIG. 6, the image generation portion 21 generates the query image 53 on the basis of the query text 51. The image generation portion 21 can generate the plurality of different query images 53.

Next, in Step S11, the image search portion 23 calculates a degree of similarity 58 between the search target image 33 and the query image 53. Specifically, the image search portion 23 calculates the degrees of similarity 58 between the plurality of search target images 33 generated on the basis of the plurality of search target texts 35 and each of the plurality of query images 53. The description of Step S03 shown in FIG. 6 can be referred to for Step S11 by replacing the degree of similarity with the degree of similarity 58 as appropriate, for example.

In Step S12, the image search portion 23 calculates a degree of similarity 59 between the search target text 35 and the query text 51. Specifically, the image search portion 23 calculates the degrees of similarity 59 between the plurality of search target texts 35 and the query text 51. For example, the search target texts 35 and the query text 51 can be converted into distributed representations, and the degrees of similarity between these distributed representations can be used as the degrees of similarity 59.

Step S12 can be performed in parallel with Step S02 and Step S11. Note that Step S12 may be performed after Step S02 and Step S11, or Step S02 and Step S11 may be performed after Step S12.

Next, in Step S13, the image search portion 23 specifies at least one of the plurality of search target images 33 and at least one of the plurality of search target texts 35 on the basis of the degrees of similarity 58 calculated in Step S11 and the degrees of similarity 59 calculated in Step S12. The specified search target image 33 is used as the output image 37. The specified search target text 35 is used as the output text 39.

For example, the search target image 33 and the search target text 35 in which at least one of the degree of similarity 58 and the degree of similarity 59 is high can be used as the output image 37 and the output text 39. In other words, the search target image 33 with a high degree of similarity 58 and the search target text 35 on which the search target image 33 is based can be used as the output image 37 and the output text 39. Furthermore, the search target text 35 with a high degree of similarity 59 and the search target image 33 generated on the basis of the search target text 35 can be used as the output text 39 and the output image 37.

For example, the search target image 33 and the search target text 35 in which at least one of the degree of similarity 58 and the degree of similarity 59 is higher than or equal to a predetermined value can be used as the output image 37 and the output text 39. For example, predetermined numbers of search target images 33 and search target texts 35 counted from those with the higher one of the highest degree of similarity 58 and the highest degree of similarity 59 can be used as the output image 37 and the output text 39. Note that, as in Step S04 shown in FIG. 6, in addition to the search target image 33 specified by the above-described method, other search target images 33 generated on the basis of the search target text 35 on which the search target image 33 is based may be included in the output image 37.

Next, as in Step S06 shown in FIG. 6, the image search portion 23 outputs the output image 37 and the output text 39 to the output portion 13. The above is the example of the document search method of one embodiment of the present invention.

Note that the degree of similarity between the search target texts 35 may be calculated in advance by the image search portion 23 and may be stored in the image storage portion 22. Thus, in the case where a document designated from the search target documents 31 is used as a query document and a text designated from the search target texts 35 included in the query document is used as the query text 51, the degree of similarity stored in the image storage portion 22 can be used as the degree of similarity 59. Hence, Step S12 can be omitted. Accordingly, the time taken from Step S01 to Step S06 can be shortened. As described above, the degree of similarity between the search target images 33 may be calculated in advance by the image search portion 23 and may be stored in the image storage portion 22. In that case, Step S11 can be omitted.

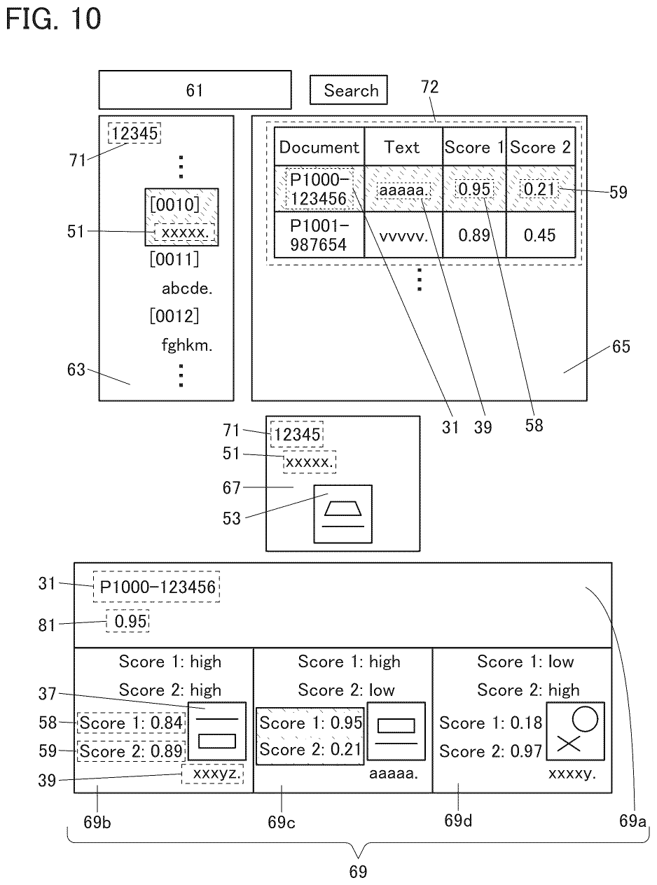

FIG. 10 is a schematic view illustrating an example of a display mode of search results obtained by the document search method shown in FIG. 9, and illustrates an example of a screen layout of the display device included in the document search device 10, for example. FIG. 10 is also regarded as an example of a GUI. The screen layout illustrated in FIG. 10 is a modification example of the screen layout illustrated in FIG. 8A. Differences from FIG. 8A are mainly described below, and the description of the same points is omitted as appropriate.

In the region 65 illustrated in FIG. 10, a “Score 1” field and a “Score 2” field are provided as the “Score” field in the table 72. The degree of similarity 58 between the search target image 33 and the query image 53 is displayed in the “Score 1” field. The degree of similarity 59 between the output text 39 and the query text 51 is displayed in the “Score 2” field. FIG. 10 illustrates an example in which the output text 39 included in the search target document 31 specified by the document number “P1000-123456” is the text “aaaaa.” and the degree of similarity 58 and the degree of similarity 59 in the text “aaaaa.” are 0.95 and 0.21, respectively. FIG. 10 also illustrates an example in which the output text 39 included in the search target document 31 specified by the document number “P1001-987654” is the text “vvvvv.” and the degree of similarity 58 and the degree of similarity 59 in the text “vvvvv.” are 0.89 and 0.45, respectively.

In the region 65 illustrated in FIG. 10, the items in the table 72 can be sorted according to “Score 1” and displayed, for example. That is, the items can be displayed in descending order of the degree of similarity 58. In the region 65 illustrated in FIG. 10, the items in the table 72 can be sorted according to “Score 2” and displayed, for example. That is, the items can be displayed in descending order of the degree of similarity 59. Note that the items may be sorted according to “Document” or “Text” and displayed. As described above, in the case where the items are sorted according to “Document”, the items can be displayed in the order of the document number, for example.

As described above, the user of the document search device 10 can designate at least one of the output texts 39 included in the “Text” field of the table 72. The designated output text 39 can be highlighted. The search target document 31 including the designated output text 39, the degree of similarity 58, and the degree of similarity 59 can also be designated and highlighted. FIG. 10 illustrates an example in which the document number “P1000-123456”, the text “aaaaa.”, the score 1 “0.95”, and the score 2 “0.21” are designated and highlighted.

In the screen layout illustrated in FIG. 10, the region 69 is divided into a region 69a, a region 69b, a region 69c, and a region 69d. The region 69a displays the designated search target document 31. For example, the region 69a can display the search target document 31 by displaying information specifying the search target document 31. A degree of similarity 81 is also displayed. The degree of similarity 81 can be, for example, one or both of the degree of similarity 58 and the degree of similarity 59 in the designated search target document 31. For example, the region 69a can display, as the degree of similarity 81, the higher one of the degree of similarity 58 and the degree of similarity 59 in the designated search target document 31. FIG. 10 illustrates an example in which the region 69a displays the document number “P1000-123456” as the search target document 31 and the score “0.95” as the degree of similarity 81. Note that the region 69a may display the search target document 31 itself including the designated output text 39, like the region 69 illustrated in FIG. 8A and FIG. 8B.

The designated output text 39, the designated degree of similarity 58, and the designated degree of similarity 59 can be displayed on any of the region 69b, the region 69c, and the region 69d. Specifically, they can be displayed on the region 69b when both the degree of similarity 58 and the degree of similarity 59 are high, they can be displayed on the region 69c when the degree of similarity 58 is high and the degree of similarity 59 is low, and they can be displayed on the region 69d when the degree of similarity 58 is low and the degree of similarity 59 is high. For example, in the case where the total of the degree of similarity 58 and the degree of similarity 59 is greater than or equal to a predetermined value, the designated output text 39, the designated degree of similarity 58, and the designated degree of similarity 59 can be displayed on the region 69b. For another example, in the case where the degree of similarity 58 is higher than the degree of similarity 59 and the difference between the degree of similarity 58 and the degree of similarity 59 is greater than or equal to a predetermined value, the designated output text 39, the designated degree of similarity 58, and the designated degree of similarity 59 can be displayed on the region 69c. For another example, in the case where the degree of similarity 58 is lower than the degree of similarity 59 and the difference between the degree of similarity 59 and the degree of similarity 58 is greater than or equal to a predetermined value, the designated output text 39, the designated degree of similarity 58, and the designated degree of similarity 59 can be displayed on the region 69d. The output image 37 generated on the basis of the output text 39 can be displayed on any of the region 69b, the region 69c, and the region 69d. FIG. 10 illustrates an example in which the region 69c displays the text “aaaaa.” as the designated output text 39, the score 1 “0.95” as the degree of similarity 58, and the score 2 “0.21” as the degree of similarity 59. FIG. 10 also illustrates an example in which the region 69c displays the output image 37 used for calculating the designated degree of similarity 58.

The region not displaying the designated output text 39, the designated degree of similarity 58, the designated degree of similarity 59, or the like among the region 69b, the region 69c, and the region 69d can display the designated search target document 31, i.e., the output text 39 included in the search target document 31 displayed on the region 69a. For example, in the case where the region 69c displays the designated output text 39, the designated degree of similarity 58, the designated degree of similarity 59, and the like, the region 69b can display the output text 39 in which the total of the degree of similarity 58 and the degree of similarity 59 is the highest and the degree of similarity 58 and the degree of similarity 59 in the output text 39. The region 69b can also display the output image 37 generated on the basis of the output text 39. The region 69d can display the output text 39 in which the difference between the degree of similarity 59 and the degree of similarity 58 is the largest and the degree of similarity 58 and the degree of similarity 59 in the output text 39, for example. The region 69d can also display the output image 37 generated on the basis of the output text 39. FIG. 10 illustrates an example in which the region 69b displays the score 1 “0.84” as the degree of similarity 58, the score 2 “0.89” as the degree of similarity 59, and a text “xxxyz.” as the output text 39. FIG. 10 also illustrates an example in which the region 69d displays the score 1 “0.18” as the degree of similarity 58, the score 2 “0.97” as the degree of similarity 59, and a text “xxxxy.” as the output text 39. Note that in the case where the designated output text 39, the designated degree of similarity 58, the designated degree of similarity 59, and the like are displayed on the region 69b or the region 69d, the region 69c can display the output text 39 in which the difference between the degree of similarity 58 and the degree of similarity 59 is the largest and the degree of similarity 58 and the degree of similarity 59 in the output text 39, for example. The region 69c can also display the output image 37 generated on the basis of the output text 39.

Note that as in the example illustrated in FIG. 8B, the plurality of query images 53 may be displayed on the region 67, and the plurality of output images 37 may be displayed on each of the region 69b, the region 69c, and the region 69d. The region not displaying the designated output text 39, the designated degree of similarity 58, the designated degree of similarity 59, or the like among the region 69b, the region 69c, and the region 69d may display the output text 39 included in the search target document 31 other than the designated search target document 31.

Although FIG. 10 illustrates an example in which one output text 39 is displayed on the region not displaying the designated output text 39, the designated degree of similarity 58, the designated degree of similarity 59, or the like, the plurality of output texts 39 may be displayed on the region. For example, the region 69b may display a plurality of combinations each including the output text 39, the output image 37, the degree of similarity 58, and the degree of similarity 59 in descending order of the total of the degree of similarity 58 and the degree of similarity 59. The region 69d may display a plurality of combinations each including the output text 39, the output image 37, the degree of similarity 58, and the degree of similarity 59 in descending order of the difference between the degree of similarity 59 and the degree of similarity 58. Furthermore, in the case where the region 69c is the region not displaying the designated output text 39, the designated degree of similarity 58, the designated degree of similarity 59, or the like, the region 69c may display a plurality of combinations each including the output text 39, the output image 37, the degree of similarity 58, and the degree of similarity 59 in descending order of the difference between the degree of similarity 58 and the degree of similarity 59. Note that the plurality of output texts 39 may be displayed on a region displaying the designated output text 39, the designated degree of similarity 58, the designated degree of similarity 59, and the like. That is, the region may display the output text 39 other than the designated output text 39. For example, the undesignated output text 39 may be displayed below the designated output text 39.

Here, the region 69 preferably performs display such that the user of the document search device 10 can recognize the region displaying the designated output text 39, the designated degree of similarity 58, the designated degree of similarity 59, and the like. In FIG. 10, the score 1 and the score 2 displayed on the region 69c are highlighted to indicate display of the designated output text 39, the designated degree of similarity 58, the designated degree of similarity 59, and the like on the region 69c.

The output text 39 displayed on the region 69b can be interpreted as, for example, having a sentence structure, a word or phrase, and the like similar to those of the query text 51 and representing a concept similar to that of the query text 51. The output text 39 displayed on the region 69c can be interpreted as, for example, having a sentence structure, a word or phrase, and the like different from those of the query text 51 but representing a concept similar to that of the query text 51. The region 69c can display a text that has been difficult to present by a search based only on the degree of similarity 59 between the search target text 35 and the query text 51. The output text 39 displayed on the region 69d can be interpreted as, for example, having a sentence structure, a word or phrase, and the like similar to those of the query text 51 but representing a concept different from that of the query text 51. The region 69d can display a text serving as noise in a search based only on the degree of similarity 59.

As described above, the user of the document search device 10 can obtain a wide range of information relating to the query text 51. Thus, a highly convenient document search device and a highly convenient document search method can be achieved.

In this manner, the document search device and the document search method of one embodiment of the present invention can search for a document including a text whose concept is similar to but represented differently from a desired concept and present the document to the user of the document search device. Thus, a highly convenient document search device and a highly convenient document search method can be achieved.

### REFERENCE NUMERALS

10: document search device, 11: input portion, 13: output portion, 20: document storage portion, 21a: encoder, 21b: decoder, 21: image generation portion, 22: image storage portion, 23: image search portion, 31: search target document, 32: search target document group, 33: search target image, 34: search target image group, 35: search target text, 36: search target text group, 37: output image, 39: output text, 41: learning document, 43: learning image, 45: image label, 47: main text, 49: learning text, 51: query text, 53: query image, 55: degree of similarity, 56: degree of similarity, 57: degree of similarity, 58: degree of similarity, 59: degree of similarity, 61: input field, 63: region, 65: region, 67: region, 69a: region, 69b: region, 69c: region, 69d: region, 69: region, 81: degree of similarity, 90: image caption generation model, 91a: encoder, 91b: decoder, 93: image, 95: distributed representation, 97: text, 100: terminal, 101: information terminal, 103: information terminal, 105: housing, 107: information terminal, 110: image classification model, 111: input layer, 113: intermediate layer, 115: output layer, 117: image, 119: classification, 120: network, 121[1]: distributed representation, 121[2]: distributed representation, 121[3]: distributed representation, 123: noise, 130: server

1. A document search device comprising:
an input portion and an output portion,
wherein the input portion is configured to receive a query text,
wherein the output portion is configured to present an output text specified from a plurality of search target texts in each of a plurality of search target documents included in a search target document group, and
wherein the output portion is configured to present one query image or at least one of a plurality of query images generated on the basis of the query text and an output image specified from one or more images generated on the basis of the output text.

2. The document search device according to claim 1,
wherein the output portion is configured to present information specifying the search target document comprising the output text.

3. The document search device according to claim 1,
wherein the query image is an image generated using a machine learning model.

4. The document search device according to claim 3,
wherein the machine learning model is a neural network model.

5. The document search device according to claim 1,
wherein the output image is specified on the basis of degrees of similarity between search target images generated from the plurality of search target texts and the query image.

6. A document search method comprising:
a first step of receiving a query text;
a second step of generating a plurality of query images on the basis of the query text;
a third step of calculating degrees of similarity between a plurality of search target images generated on the basis of a plurality of search target texts in each of search target documents in a search target document group and each of the plurality of query images;
a fourth step of specifying at least one of the plurality of search target images on the basis of the degrees of similarity; and
a fifth step of specifying the search target text used in generation of the specified search target image.

7. The document search method according to claim 6,
wherein, in the second step, a distributed representation is generated on the basis of the query text and the plurality of query images are generated on the basis of the distributed representation.

8. The document search method according to claim 6,
wherein, in the third step, the degrees of similarity are obtained by calculating a degree of similarity between a first distributed representation generated from each of the plurality of query images and a second distributed representation generated from each of the plurality of search target images.

9. The document search method according to claim 8,
wherein the first distributed representation and the second distributed representation are generated using an image classification model or an image caption generation model.

10. The document search method according to claim 6,
wherein, in the third step, the query images are classified as a first classification, the plurality of search target images are classified as a second classification, and then degrees of similarity between the search target image selected from the plurality of search target images on the basis of the first classification and the second classification and the query images are calculated.

11. The document search method according to claim 6,
wherein, in the third step, the query text is classified as a first classification, the search target texts are classified as a second classification, and then degrees of similarity between the search target image selected from the plurality of search target images on the basis of the first classification and the second classification and the query images are calculated.

12. A document search method comprising:
a first step of receiving a query text;
a second step of generating a plurality of query images on the basis of the query text;
a third step of calculating first degrees of similarity between a plurality of search target images generated on the basis of a plurality of search target texts in each of search target documents in a search target document group and each of the plurality of query images;
a fourth step of calculating second degrees of similarity between the plurality of search target texts and the query text; and
a fifth step of specifying at least one of the plurality of search target images and at least one of the plurality of search target texts on the basis of the first degrees of similarity and the second degrees of similarity.
